(19) United States
(12) Patent Application Publication
(10) Pub. No.: US 2016/0063307 A1
(43) Pub. Date: Mar. 3, 2016

(54) IMAGE ACQUISITION DEVICE AND CONTROL METHOD THEREFOR

(71) Applicant: CANON KABUSHIKI KAISHA, Tokyo (JP)

(72) Inventor: Takeshi Iwasa, Tokyo (JP)

(21) Appl. No.: 14/820,811

(22) Filed: Aug. 7, 2015

(30) Foreign Application Priority Data
Aug. 29, 2014 (JP) 2014-175944
May 22, 2015 (JP) 2015-104802

(51) Int. Cl. G06K 9/00; G06T 7/00; H04N 7/18; G02B 21/36; G02B 21/26

(52) U.S. Cl. CPC G06K 9/00127; G02B 21/36; G02B 21/26; H04N 7/183; G06T 7/0012; G06T 2207/10056; G06T 2207/30024

(57) ABSTRACT

The image acquisition device has a stage that supports the sample, and an imaging unit that has an image forming optical system forming an image of the sample and captures the formed image. The image acquisition device further includes a specimen information acquisition unit that acquires information on presence or absence of a specimen included in the sample based on an imaging result of the imaging unit, and a control unit that moves the stage based on the information on the presence or absence of the specimen.

### BACKGROUND OF THE INVENTION

1. Field of the Invention

The present invention relates to an image acquisition device and a control method therefor.

2. Description of the Related Art

Recently, in the field of pathology, an image acquisition device such as a virtual slide system that acquires a microscope image of a pathological sample such as a tissue slice as a digital image attracts attention. With digitization of a pathological diagnosis image, an improvement in efficiency of data management and remote diagnosis are allowed.

A sample serving as an imaging target of the device is mainly a slide (also referred to as a prepared slide), and a tissue slice that is sliced so as to have a size of several to several tens of [um] is fixed between a slide glass and a cover glass via an encapsulant. In general, the thickness of the tissue slice is not always constant, its surface has asperities, and the tissue slice itself is not always in a substantially flat shape and is undulated. Accordingly, in order to acquire a focused image of the entire area of the tissue slice in a thickness direction via an optical system of a pathological observation microscope of which the depth of field is shallow (about 0.5 to 1 [um]) due to its high resolution, it is necessary to properly set the presence range of the tissue slice in the thickness direction for each imaging range as an imaging field of the device. By doing so, the presence range of the tissue slice in the thickness direction is caused to substantially match a range of an imaging layer in an optical axis direction, and the focused image of the entire area of the tissue slice in the thickness direction can be thereby acquired properly via the optical system of the pathological observation microscope having the shallow depth of field.

As the assumption of execution of the foregoing, the following is required in order to acquire imaging data over the entire area of the tissue slice via the optical system and an imaging system of the pathological observation microscope of which the imaging range is often not more than about 1 [square mm] due to its high resolution. That is, it is necessary to properly set the imaging range in a direction orthogonal to the optical axis, and join a large number of image data items that are acquired for the individual imaging ranges of the device together. This is achieved by, e.g., repeatedly imaging the entire area of the slide sequentially according to a predetermined movement procedure. However, this operation has a problem that the operation itself is a time-consuming operation and there are many unnecessary data items in a range in which a specimen is not present.

To cope with this problem, there is proposed a method in which an imaging process is performed every time a stage on which the slide is placed is horizontally moved a predetermined distance or more by an operation of a user (Japanese Patent Application Laid-open No. 2011-186305).

In addition, there is known a method in which the presence range of the tissue slice, i.e., the specimen is extracted from an image of the entire area of the slide and a detailed enlarged image is acquired in the extracted range (Japanese Patent Application Laid-open No. 2007-233093).

Patent Literature 1: Japanese Patent Application Laid-Open No. 2011-186305

Patent Literature 2: Japanese Patent Application Laid-Open No. 2007-233093

### SUMMARY OF THE INVENTION

However, the conventional image acquisition devices described above have had the following problems. That is, in the method of Japanese Patent Application Laid-open No. 2011-186305 in which the user searches for the presence range of the specimen, there have been cases where the imaging takes time because it is performed manually, and an omission occurs in the specimen search.

In the method of Japanese Patent Application Laid-open No. 2007-233093 in which the specimen presence range is automatically extracted from a wide-area image, a wide-area imaging portion having high resolution and a specimen detection algorithm having high accuracy are essential. Accordingly, the cost of the device has been increased and it has been difficult to properly acquire a wide-range microscope image of the specimen in the case where there is an error in the specimen detection.

The invention according to the present application has been achieved in view of the above problems, and an object thereof is to provide the image acquisition device capable of determining the imaging range at high speed with high accuracy using a simple configuration, and a control method for the image acquisition device.

In order to achieve the above object, the present invention adopts the following configuration. That is, the present invention adopts an image acquisition device dividing a sample into a plurality of areas and sequentially imaging the areas, comprising:

a stage that supports the sample;

an imaging unit that has an image forming optical system forming an image of the sample and captures the formed image;

a specimen information acquisition unit that acquires information on presence or absence of a specimen included in the sample based on an imaging result of the imaging unit; and

a control unit that moves the stage based on the information on the presence or absence of the specimen, wherein

the specimen information acquisition unit determines, based on an image of a first area of the sample captured by the imaging unit, the presence or absence of the specimen in a second area of the sample different from the first area, and

the control unit moves the stage in order to image the second area next when the specimen is determined to be present in the second area.

In addition, the present invention adopts the following configuration. That is, the present invention adopts a control method for an image acquisition device including a stage that supports a sample, and an imaging unit that captures an image of the sample, comprising the steps of:

capturing an image of a first area of the sample;

determining presence or absence of a specimen in a second area of the sample different from the first area based on the image of the first area; and

moving the stage in order to image the second area next when the specimen is determined to be present in the second area.

Further, the present invention adopts the following configuration. That is, the present invention adopts a non-transitory computer readable storage medium storing a program for causing a computer to execute steps of a control method for an image acquisition device including a stage that supports a sample, and an imaging unit that captures an image of the sample, the method comprising the steps of:

capturing an image of a first area of the sample;

determining presence or absence of a specimen in a second area of the sample different from the first area based on the image of the first area; and

moving the stage in order to image the second area next when the specimen is determined to be present in the second area.

As described thus far, according to the present invention, it is possible to provide the image acquisition device capable of determining the imaging range at high speed with high accuracy using the simple configuration and the control method for the image acquisition device.

Further features of the present invention will become apparent from the following description of exemplary embodiments with reference to the attached drawings.

### BRIEF DESCRIPTION OF THE DRAWINGS

FIG. 1A is a block diagram showing a first embodiment of an image acquisition device of the present invention (first embodiment);

FIG. 1B is a cross-sectional view showing a slide of the image acquisition device in the first embodiment;

FIGS. 2A and 2B are flowcharts showing an imaging process of the image acquisition device in the first embodiment;

FIGS. 3A to 3C are schematic diagrams showing Z search imaging in the first embodiment;

FIG. 4 is a flowchart showing the Z search imaging in the first embodiment;

FIGS. 5A to 5C are schematic views showing a calculation method of an XY imaging range in the first embodiment;

FIGS. 6A to 6C are schematic diagrams showing a second embodiment of the image acquisition device of the present invention (second embodiment);

FIGS. 7A and 7B are schematic diagrams showing a third embodiment of the image acquisition device of the present invention (third embodiment);

FIGS. 8A and 8B are flowcharts showing a fourth embodiment of the image acquisition device of the present invention (fourth embodiment);

FIGS. 9A to 9C are schematic views showing a search method of a Z direction imaging range in the fourth embodiment;

FIG. 10 is a flowchart showing Z-stack of the fourth embodiment;

FIGS. 11A and 11B are views showing a setting method of a Z-stack range in the fourth embodiment;

FIGS. 12A and 12B are perspective views showing a fifth embodiment of the image acquisition device of the present invention (fifth embodiment); and

FIGS. 13A and 13B are perspective views showing a sixth embodiment of the image acquisition device of the present invention (sixth embodiment).

### DESCRIPTION OF THE EMBODIMENTS

Hereinbelow, embodiments of the present invention will be described by using the drawings. Note that the following embodiments are not intended to limit the scope of claims of the invention, and all of combinations of features described in the embodiments are not necessarily essential to means for solving the problem of the invention.

### First Embodiment

### (Device Configuration)

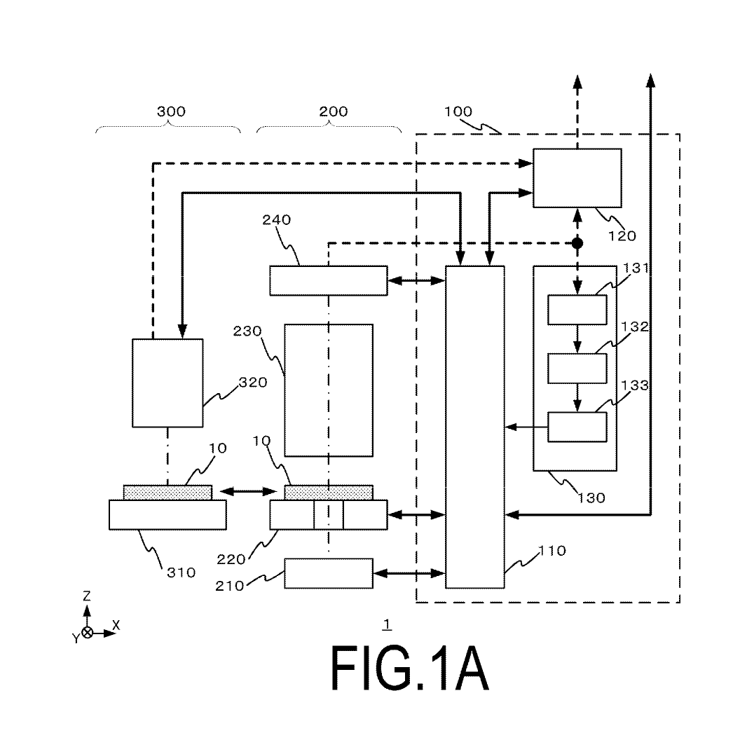

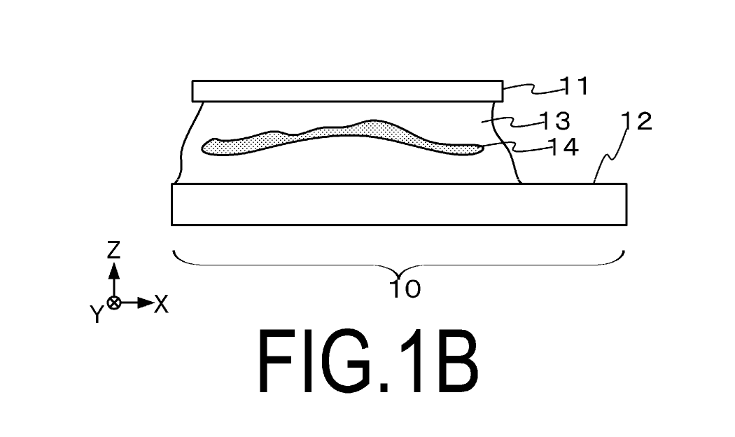

FIG. 1A is a block diagram showing a first embodiment of an image acquisition device of the present invention. An image acquisition device 1 (hereinafter simply referred to as a “device 1”) includes a main imaging device 200 (corresponds to imaging means) that performs main imaging, a wide-area imaging device 300 (corresponds to wide-area imaging means) that performs preliminary imaging prior to the main imaging, and a main body control portion 100 that performs operation control of the device and image processing. In the drawing, broken line arrows represent data signals related to image information, and solid line arrows represent a control command signal and a status signal. First, the summaries thereof will be described. Although there are other components that are not shown, they will be described later on an as needed basis.

The main imaging device 200 captures a microscope image of a slide 10 as a sample in which a specimen such as a tissue slice is encapsulated. The main imaging device 200 includes an illumination portion 210 that illuminates the slide 10 (sample), a stage 220, a lens portion 230, and an imaging element 240. The stage 220 positions the slide 10 and also supports the slide 10. The lens portion 230 is an image forming optical system that collects light from the slide 10 and forms an image. The imaging element 240 converts the light of the formed image to an electrical signal. Note that, in the present embodiment, as shown in FIG. 1A, an optical axis direction of the lens portion 230 is defined as a Z direction, and a horizontal plane direction orthogonal to the optical axis direction is defined as an XY direction. With regard to an imaging method, a multi-layer image (Z-stack image) of a specimen 14 described later is acquired for each small section described later. Hereinbelow, this multi-layer image is referred to as the Z-stack image. The Z-stack image denotes a plurality of two-dimensional images obtained as a result of imaging a subject while slightly changing a focal position in the optical axis direction. That is, the Z-stack image denotes an image obtained as a result of imaging the subject at each focal position. The Z-stack means a process in which a plurality of the two-dimensional images are obtained by imaging the subject while slightly changing the focal position in the optical axis direction. The two-dimensional image at each focal position that constitutes the Z-stack image is referred to as a layer image.

The wide-area imaging device 300 captures the entire image of the slide 10 when viewed from above, and includes a sample placement portion 310 on which the slide 10 is placed, and a wide-area imaging portion 320 that images the slide 10. The image acquired by the wide-area imaging portion 320 is used for production of a thumbnail image of the slide 10, division and generation of a small section 801 described later, and acquisition of sample identification information in the case where the sample identification information in the form of a bar code or a two-dimensional code is described in the slide 10.

The main body control portion 100 has a control portion 110 that performs the operation control of the device 1 and communication with an external device that is not shown, and a image processing portion 120 that performs image processing on imaging data of the wide-area imaging portion 320 and the imaging element 240 and outputs image data to an external device that is not shown. Further, the main body control portion 100 has an arithmetic operation portion 130 (corresponds to specimen information acquisition means) that performs operations related to focusing. Note that, in the drawing, the main body control portion 100 is divided into blocks according to functions for the sake of convenience but, as its implementation means, the main body control portion 100 may be implemented as software operating on a CPU or a DSP or implemented as hardware such as an ASIC or an FPGA, and the division thereof may be designed appropriately. The external device that is not shown includes a PC workstation that functions as a user interface between the device 1 and the user or an image viewer, and an external storage device or an image management system that performs storage and management of image data. In addition, components included in the device 1 that are not shown include a slide stocker in which a large number of the slides 10 are set, and sample transport means for transporting the slide 10 to a placement stand, i.e., the sample placement portion 310 and the stage 220. The detailed description of these components that are not shown will be omitted.

The components described above will be further described. The illumination portion 210 includes a light source that emits light and an optical system that concentrates light onto the slide 10. As the light source, a halogen lamp and an LED are used. The stage 220 has a position control mechanism that holds the slide 10 and moves it precisely in the XY and Z directions, and the position control mechanism is implemented by a drive mechanism such as the combination of a motor and a ball screw and a piezoelectric element. In addition, the stage 220 includes a slide holding and fixing mechanism such as a vacuum in order to prevent a position displacement of the slide 10 caused by acceleration during the stage movement. The lens portion 230 includes an objective lens and an image forming lens, and forms an image of transmitted light of the slide 10 emitted from the illumination portion 210 on a light receiving surface of the imaging element 240. As the lens, a lens having a field of view (FOV: imaging range) on an object side of about 1 [square mm] and a depth of field of about 0.5 [um] is preferable. The imaging element 240 is an image sensor that uses a charge-coupled device (CCD), a complementary metal oxide semiconductor (CMOS) or the like. The imaging element 240 converts received light to an electrical signal by photoelectric conversion according to an exposure time, a sensor gain, and an exposure start timing set based on control signals from the control portion 110, and outputs the electrical signal to the image processing portion 120 and the arithmetic operation portion 130. The sample placement portion 310 is a stand for placing the slide 10. A pushing mechanism is provided on the stand so as to be able to position an XY position of the slide 10 relative to the sample placement portion 310. Note that the configuration is not limited to the configuration of FIG. 1A, and the stage 220 may also function as the sample placement portion 310. In this case, the configuration can be realized by increasing an XY movable range of the stage 220.

The wide-area imaging portion 320 includes an illumination portion (not shown) that irradiates the slide 10 placed on the sample placement portion 310 with illumination light, and a camera portion (not shown) that includes a lens and an imaging element. The exposure time, the sensor gain, the exposure start timing, and an illumination amount are set based on the control signals from the control portion 110, and imaging data is outputted to the image processing portion 120. Note that the power and the position of the wide-area imaging portion 320 are configured such that dark field illumination can be performed by a ring illuminator provided around the lens and the entire image of the slide 10 can be captured by one imaging. The resolution or the resolving power of the camera portion may be a low resolution or a low resolving power that allows recognition of the imaging range in the main imaging device 200 or the two-dimensional code such that rough detection of the presence range of the specimen 14 can be performed, and hence the camera portion can be configured at low cost.

The control portion 110 performs the operation control of each component of the device 1 based on an operation process described later. Specifically, the control portion 110 sets an operation condition and issues an instruction related to an operation timing. For the wide-area imaging portion 320, the control portion 110 performs the setting and control of the exposure time, the sensor gain, the exposure start timing, and an illumination light amount. For the illumination portion 210, the control portion 110 issues instructions related to the amount of light, a diaphragm, and switching of a color filter. For the stage 220, the control portion 110 controls the stage 220 such that the stage is moved in the XY and Z directions so that the desired segment of the slide 10 can be imaged based on an output result of the arithmetic operation portion 130, information on the small section 801 described later, and current position information on the stage by an encoder that is not shown. For the imaging element 240, the control portion 110 performs the setting and control of the exposure time, the sensor gain, and the exposure start timing. The control portion 110 performs setting and control of an operation mode and a timing and reception of a process result of wide-area imaging data such as information on the small section or the bar code with the image processing portion 120. Further, the control portion 110 performs communication with an external device that is not shown. Specifically, the control portion 110 acquires an operation condition set via the external device by a user, controls an operation start/stop of the device, and issues an instruction related to the output of image data to the image processing portion 120.

The image processing portion 120 has mainly two functions. One of the functions is processing of wide-area imaging data of the slide 10 received from the wide-area imaging portion 320. The image processing portion 120 performs analysis of the wide-area imaging data, reading of bar code information, rough detection of the presence range of the specimen 14 in the XY direction, division and generation of a group of the small sections 801, and generation of the thumbnail image. The word “rough” mentioned here denotes, e.g., that, as described above, the resolution or the resolving power of the wide-area imaging portion 320 is lower than that of the main imaging device 200. With this configuration, the wide-area imaging portion 320 can be configured at low cost, and the calculation amount is reduced at the time of the image processing, and hence the speed of the image processing is increased. Herein, the control portion 110 controls a main imaging process that uses the main imaging device 200 based on information on the group of the generated small sections 801 (coordinates, the number of sections and the like). Note that the division and generation of the group of the small sections 801 will be described in detail in the section of (calculation of XY direction imaging range in first embodiment). The second function is processing of main imaging data on the slide 10 received from the imaging element 240. The main imaging data is subjected to various correction processes of a sensitivity difference between RGB and a γ curve, data compression performed on an as needed basis, and protocol conversion, and the data is transmitted to external devices such as a viewer and an image storage device based on the instruction from the control portion 110.

The arithmetic operation portion 130 includes a distribution calculation portion 131, a specimen estimation portion 132, and a setting portion 133. The arithmetic operation portion 130 determines an XY direction imaging position and a Z direction imaging position after performing operations related to focus search, AF, and the imaging range based on the main imaging data received from the imaging element 240. Subsequently, the arithmetic operation portion 130 outputs the determination result to the control portion 110. The distribution calculation portion 131 calculates a two-dimensional distribution of a focus evaluation index (e.g., a contrast value) of each pixel of the main imaging data, and outputs the calculation result to the specimen estimation portion 132. Note that image processing techniques can be applied without alteration by using the contrast value as the focus evaluation index. The specimen estimation portion 132 outputs information on the presence or absence of the specimen in a surrounding area estimated by a method described later to the setting portion 133. The setting portion 133 sets the small section 801 that is imaged next based on the estimation result, and outputs the setting result to the control portion 110. Note that the operation of the arithmetic operation portion 130 will be described in detail in the section of (calculation of XY direction imaging range in first embodiment).

Note that the implementation of the present invention is not limited to the present embodiment. For example, the present invention may also have a configuration capable of acquiring also RGB color images by providing a plurality of imaging elements having color filters and causing the imaging elements to have sensitivities to lights of different wavelengths. In this case, the number of times of imaging required to obtain the color image is reduced, and hence the throughput of the device can be expected to be improved. In addition, in the case where an optical conjugate relationship is the same as that of the configuration described above, a configuration may be adopted in which, e.g., the sample is fixed to the placement stand and the positions of the imaging element and the lens portion are controlled using the stage or the like.

FIG. 1B is a cross-sectional view showing the slide of the image acquisition device in the first embodiment. In the slide 10, the specimen 14 such as a tissue slice as an imaging target is fixed between a slide glass 12 as a base for the slide and a cover glass 11 as a protection film via an encapsulant 13.

(Imaging Process)

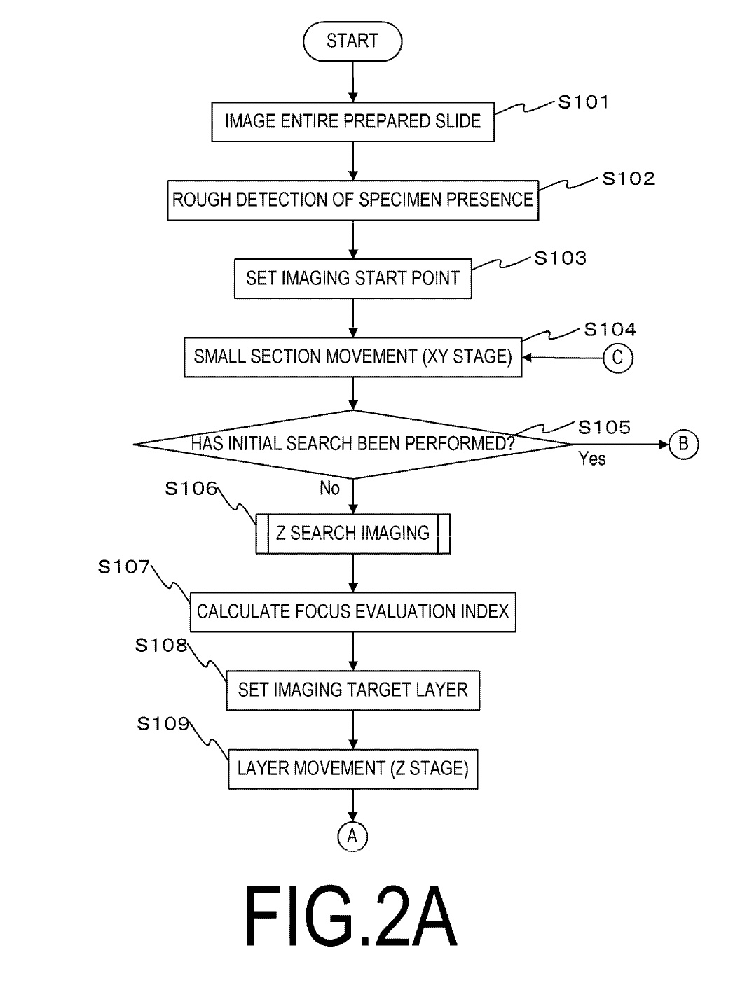

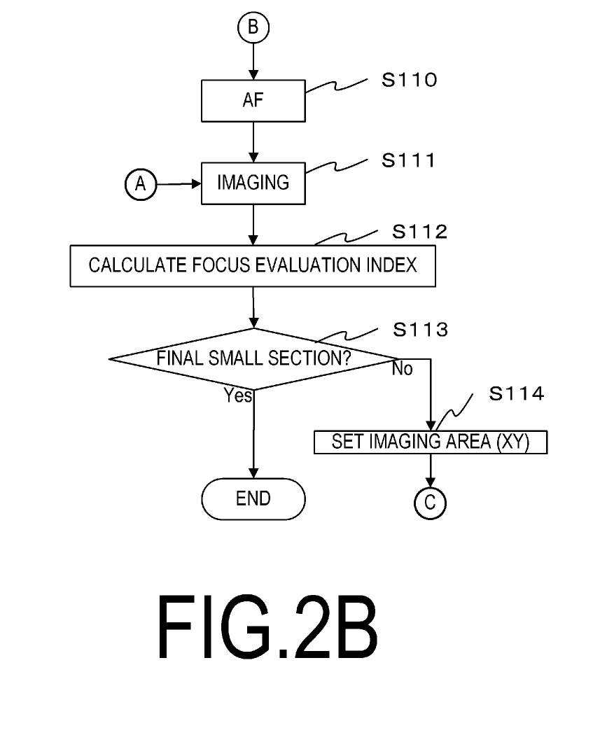

FIGS. 2A and 2B are flowcharts showing an imaging process of the image acquisition device in the first embodiment. The imaging process is roughly divided into three steps of preliminary imaging in Step S101 to Step S103, initial Z search in Step S104 to Step S108, and main imaging in Step S109 to Step S113.

The flow is started by placing the slide 10 on the sample placement portion 310. The slide may be automatically placed from a slide stacker by the sample transport means or may also be placed manually. In Step S101, the wide-area imaging device 300 images the entire area of the slide 10. In Step S102, the image processing portion 120 roughly detects the presence range of the specimen 14 on an XY plane described later based on the imaging data. The accuracy of the detection may appropriately match the accuracy of the FOV of the main imaging device 200, i.e., the imaging range thereof. That is, the size of one pixel of the image of the entire image imaged by the wide-area imaging device 300 may be not more than the imaging field (imaging range) of the main imaging device 200 appropriately. In Step S103, any small section 801 easily determined as a section in which the specimen 14 is definitely present is set as an initial imaging section. Note that the specific process method in each of Steps S102 and S103 will be described in detail in the section of (calculation of XY direction imaging range in first embodiment). Note that the slide 10 having been subjected to the wide-area imaging in parallel with Steps S102 and S103 is placed on and fixed to the stage 220. As described above, this slide movement process may be performed manually or automatically using the transport mechanism as described above. Alternatively, a configuration may also be adopted in which the stage 220 is caused to function as the sample placement portion 310 and the movement process can be thereby omitted. When Step S101 to Step S103 as the preliminary imaging are ended, the flow proceeds to Step S104.

In Step S104, the stage 220 having the slide 10 placed thereon moves such that the small section 801 in which the first imaging by the main imaging device 200 is performed is positioned immediately below the lens of the lens portion 203. This point will be specifically described later. In Step S105, it is determined whether or not an initial search process described later has been performed. At this point of time, the initial search process has not been performed (NO), the flow proceeds to Step S106. That is, NO is selected only at the first time in Step S105, and only YES is selected from the second time until all of the imaging processes to the slide 10 are ended. In Step S106, the imaging process for Z search described later that is performed only in the initial imaging section is performed. In Step S107, calculation of the focus evaluation index is performed based on multi-layer imaging data (Z-stack image data) in the Z direction acquired in Step S106. In Step S108, the focus position in the Z direction is estimated and the estimated focus position is set as an imaging target layer. The Z search in Step S106 to S108 is an imaging process for detecting the focus position in the optical axis direction, and will be described in detail in (search of Z direction focus position).

In Step S109, when the Z search performed only on the small section 801 that is imaged first is ended, the stage moves in the Z direction such that the focus position in the small section 801 can be imaged. In Step S111, the imaging is performed at the position after the movement. In Step S112, the distribution calculation portion 131 calculates the two-dimensional distribution of the focus evaluation index based on the imaging data acquired in Step S111. In Step S113, a final small section determination portion (not shown) determines whether or not the small section is the final small section. Note that the final small section determination portion may be provided in or separately from the arithmetic operation portion 130. In this case, since the small section is not the final small section (NO), the flow proceeds to Step S114. In Step S114, the adjacent small section 801 that is imaged next is set by using a method described later based on the two-dimensional distribution of the focus evaluation index of the small section 801 that has just been imaged that is calculated in Step S112. Thereafter, the flow proceeds to Step S104. Note that Steps S112 and S114 will be described in detail in the section of (calculation of XY direction imaging range in first embodiment). After the process in Step S114, the stage performs an XY movement, i.e., moves in a direction of a plane orthogonal to the optical axis to the set next small section 801. YES is selected in Step S105 again, and an AF (autofocus) operation is performed to be prepared for the imaging in Step S110. Note that the AF operation is a publically known technique, and hence the detailed description thereof will be omitted. Thereafter, the main imaging process shown in Steps S104 and S105 and Steps S110 to S114 is repeated until the imaging in all of the small sections is ended, YES is selected in Step S113 at the time of imaging of the final small section, and the above flow, i.e., the imaging process of the slide is ended.

(Search of Z Direction Focus Position)

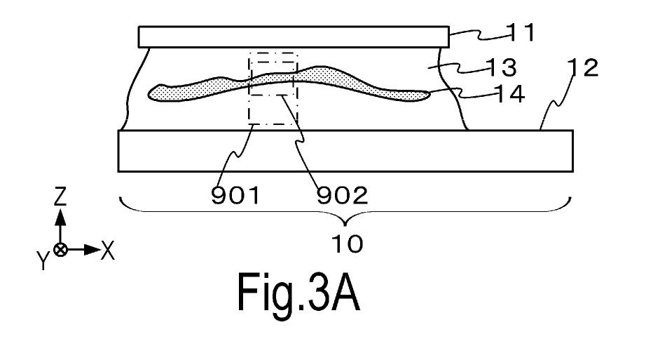

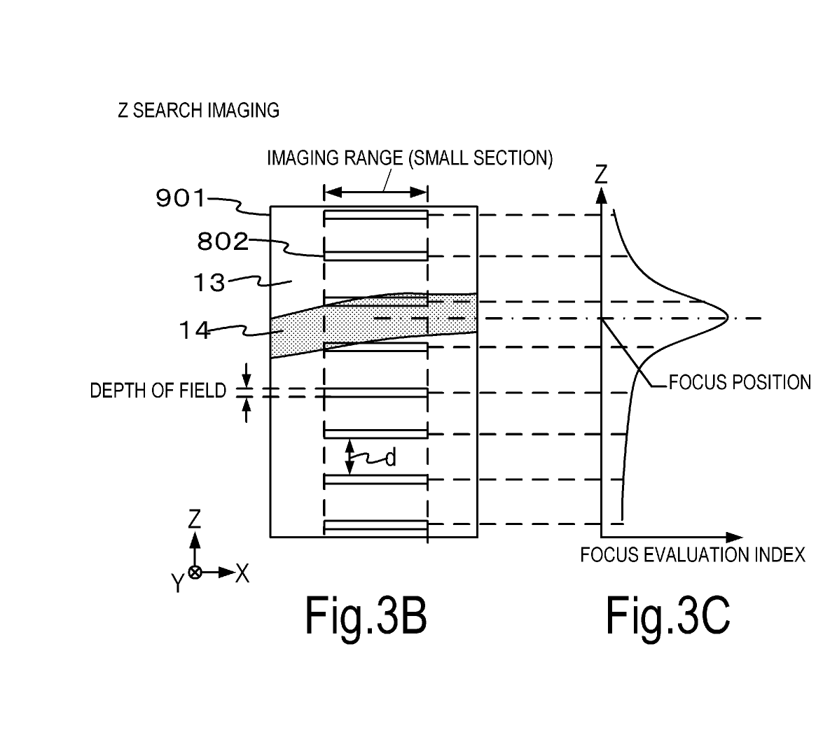

FIG. 3 is a schematic diagram showing Z search imaging in the first embodiment. FIG. 3A is a schematic view showing the transverse section of the slide 10. FIG. 3B is a view in which a one-dot chain line area 901 in a transverse sectional image of the slide 10 shown in FIG. 3A is enlarged and the method of the Z search imaging (S106) performed only on the first small section 801 is shown so as to overlap the area. An imaging range 802 is determined by the imaging range (the small section) in the XY direction and the depth of field in the Z direction, and is a three-dimensional area that can be imaged with one exposure. A plurality of the imaging ranges 802 are disposed at regular intervals in the Z direction in FIG. 3B. The imaging ranges 802 are disposed from the upper end of the area 901, i.e., a part in the vicinity of the lower end of the cover glass 11 to the lower end of the area 901, i.e., a part in the vicinity of the upper end of the slide glass 12. By setting a distance d between the imaging ranges 802 to a value substantially equal to the thickness of a thin specimen (about several um), it is possible to include all of ranges in which the specimen 14 can be present. This is because, by disposing a plurality of the imaging ranges 802 at intervals of the distance d, it is possible to include at least part of the specimen 14 in at least one of the imaging ranges 802.

FIG. 3C is a view showing the focus evaluation index distribution in the Z direction in the first embodiment. That is, FIG. 3C is a view in which the distribution of the focus evaluation index on a line parallel with the Z axis at the center of the imaging range (the small section) in FIG. 3B is schematically shown. In FIG. 3C, imaging data on eight imaging ranges 802 is interpolated in the Z direction, and the distribution of the focus evaluation index is calculated (S107). As the focus evaluation index, it is possible to use the contrast value of the image. Thus, by using the contrast value as the focus evaluation index, it is possible to constitute the device 1 without requiring sophisticated image processing techniques. A position having the maximum value of the focus evaluation index can be determined as the focus position of the specimen 14 in the Z direction. By setting the focus position as the imaging target layer (S108), preparations for acquiring an all-in-focus image of the specimen 14 in the main imaging process are made. Note that, by initially performing the search process of the Z direction focus position described above, the necessity to repeat the same process in the second and subsequent small sections 801 is obviated. When the publically known AF operation is performed in the vicinity of the focus position detected in the first small section 801, it is possible to acquire a focused specimen image. This is because the Z direction position of the specimen 14 in each of the other small sections 801 is substantially the same as the focus position detected in the first small section 801.

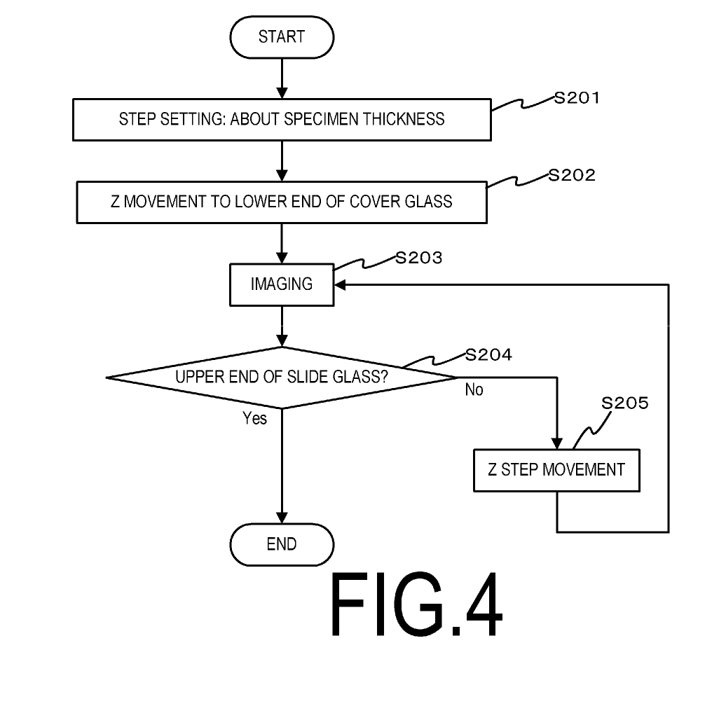

FIG. 4 is a flowchart showing the Z search imaging in the first embodiment. That is, FIG. 4 shows a flow showing a subroutine in Step S106. Hereinbelow, the Z search imaging will be described by using FIG. 4. As described above, NO is selected in Step S105 in FIGS. 2A and 2B, the flow proceeds to Step S106, and the flow is thereby started. In Step S201, first, the distance d is set to a value substantially equal to the thickness of the specimen 14. In Step S202, the stage 220 is moved according to Z movement such that the part in the vicinity of the lower end of the cover glass as the first imaging layer (the layer including the imaging range 802 closest to the lower end of the cover glass in FIG. 3B) can be imaged, and the imaging is performed in Step S203. In Step S204, it is determined whether or not the imaging layer (the layer including the imaging range 802 farthest from the lower end of the cover glass in FIG. 3B) has reached the upper end of the slide glass. In Step S205, the stage is moved by step movement in the Z direction by the distance d so that the next imaging layer can be imaged. Thereafter, Steps S203 to S205 are repeated, YES is selected in Step S204 when the imaging layer has reached the upper end of the slide glass, and the flow, i.e., the process of the Z search imaging is ended. Note that the Z step movement direction, i.e., the imaging start Z position in Step S202 and the imaging end Z position in Step S204 do not necessarily need to be in this order.

### Calculation of XY Direction Imaging Range in First Embodiment

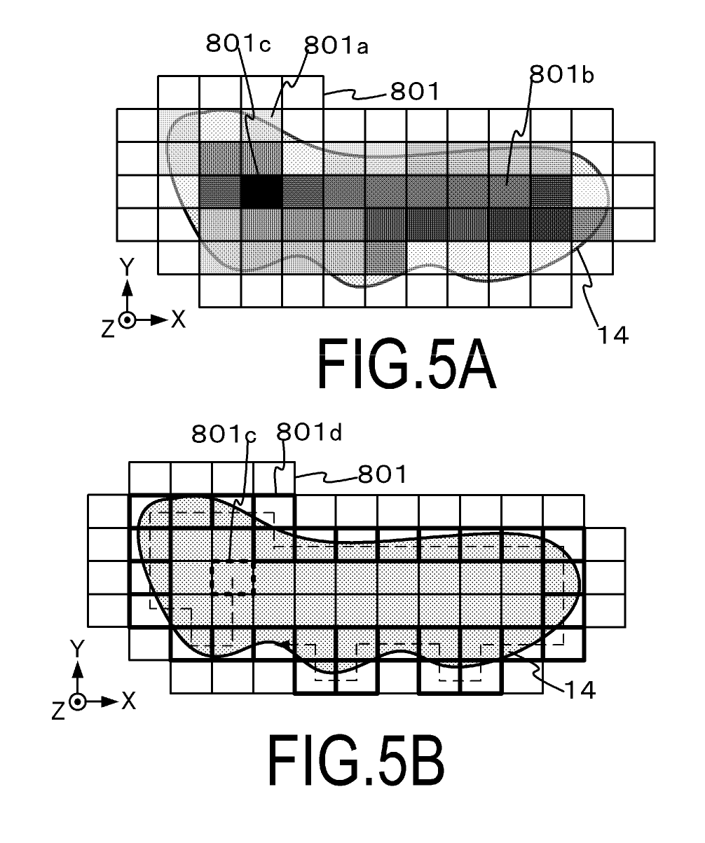

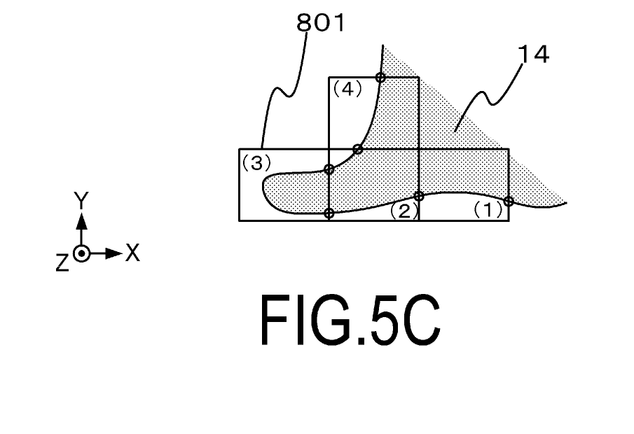

FIG. 5 is a schematic view showing a calculation method of the XY imaging range in the first embodiment. FIG. 5A schematically shows the specimen 14 and its surrounding area in the slide 10 subjected to wide-area imaging in Step S101. The size of the small section 801 is substantially equal to the size of one pixel of the wide-area imaging device 300, or the size of the small section 801 is the size obtained by averaging a plurality of pixel data items of the wide-area imaging device 300 and causing the size thereof to substantially match the FOV, i.e., the imaging range of the main imaging device 200. Note that, in order to join images of adjacent sections without displacement or distortion in subsequent image processing, the actual imaging range (the small section) is slightly larger than that shown in FIG. 5. Accordingly, sides of the adjacent small sections actually overlap each other slightly. In addition, weighting is performed such that the depth of a color with which the small section is filled is lighter with approach to the peripheral part of the specimen 14 and is darker with approach to the inner part thereof. This is the detection result of the rough detection of the specimen 14 performed in Step S102. In this weighting, the brightness and the contrast value of the wide-area imaging data can be used without changing them.

Herein, with regard to a dark-colored small section 801b, if there is wide-range imaging data having low resolution or low resolving power, it is possible to easily determine that the small section 801b is included in the presence range of the specimen 14 definitely without requiring a complicated algorithm. The reasons for this are as follows. That is, image data having high resolution and high accuracy and an image processing algorithm are required in order to specifically determine whether or not a light-colored small section 801a is included in the presence range of the specimen 14. In contrast to this, it is possible to relatively easily determine the brightness and the contrast in the case of the dark-colored small section 801b.

This is because the values of the brightness and the contrast of the dark-colored small section 801b are larger than those of the light-colored small section. In this manner, a small section 801c (the darkest part in FIG. 5A) that can be determined as the section definitely included in the specimen 14 is set as the initial imaging section 801c (S103). The setting of the small section 801c is performed by a selection portion that is not shown. The selection portion may be provided in or separately from the arithmetic operation portion 130.

Note that the selection portion sets the initial imaging section 801c in, e.g., the following manner. That is, after the wide-area imaging is performed, the selection portion acquires the brightness of each small section 801 from the wide-area imaging data, and sets the small section 801 having the smallest value of the brightness as the initial imaging section 801c that can be determined as the section definitely included in the specimen 14. Alternatively, the selection portion may acquire the brightness of each small section 801 from the wide-area imaging data, and set the small section 801 present substantially at the center of the group of the small sections each having the brightness of not less than a predetermined threshold value as the initial imaging section 801c as the small section that can be determined as the section included in the specimen 14 definitely. With this operation, the extraction of the brightness value from the imaging data can be implemented by using a simple image processing technique, and hence it is possible to easily determine and set the small section 801c by providing the selection portion described above.

FIG. 5B is a view showing an imaging route of the specimen 14. Parts corresponding to those in FIG. 5A are designated by the same reference numerals, and the description thereof will be omitted unless necessary. A rectangle represented by a thick solid line frame in the drawing is a small section 801d in which the peripheral part of the specimen 14 is included. First, the main imaging device 200 acquires the focused image of the initial imaging section 801c represented by a thick dotted line frame in the drawing by the above method.

The distribution calculation portion 131 receives data on the acquired focused image, and calculates the two-dimensional distribution of the focus evaluation index in the initial imaging section 801c based on the data. Subsequently, the distribution calculation portion 131 compares the two-dimensional distribution with a predetermined threshold value corresponding to the peripheral part of the specimen 14. The presence range of the specimen in the section 801c is calculated based on the comparison result. Specifically, the distribution of the focus evaluation index on the XY plane in the small section 801c is acquired and, among positions of the values of the focus evaluation index as the values of elements of the distribution, it is determined that the specimen 14 is present at a position (coordinates or the like) on the XY plane of the value of the focus evaluation index that exceeds the above threshold value. On the other hand, it is determined that the specimen 14 is not present at a position (coordinates or the like) on the XY plane of the value of the focus evaluation index that does not exceed the threshold value. It is possible to calculate the range in which the specimen 14 is present from the determined positions (coordinates or the like). In addition, since the distribution calculation portion 131 can determine the position where the specimen 14 is present in the small section 801c and the position where the specimen 14 is not present, the distribution calculation portion 131 may be configured to be capable of determining a boundary between an area in which the specimen 14 is present in the small section 801c and an area in which the specimen 14 is not present based on the determination result.

The specimen estimation portion 132 receives the presence range of the specimen (the two-dimensional distribution of the focus evaluation index) in the initial imaging section 801c from the distribution calculation portion 131. Herein, all of the values of the focus evaluation index of the small section 801c exceed the threshold value. In this case, the specimen estimation portion 132 determines that the small section 801c is present inside the specimen 14. That is, in the case where the boundary between the presence area of the specimen 14 and the non-presence area thereof is not included in the small section, the setting portion 133 sets the small section 801 adjacent to the small section 801c as the next imaging area according to a predetermined movement direction (y-axis negative direction) (S114).

In this manner, while moving the stage having the specimen 14 in the predetermined movement direction (the y-axis negative direction in this case), each area is imaged. Subsequently, when the specimen estimation portion 132 determines the peripheral part of the specimen 14, according to a method described later, the imaging area is moved so as to follow the peripheral part as indicated by a dotted line arrow in the drawing. With the above movement, the stage makes one revolution around the peripheral part. That is, the setting portion 133 sequentially sets the area that is imaged next so as to follow the peripheral part of the specimen 14. After making one revolution, when the small sections 801 that are not imaged yet in a range surrounded by the peripheral part are sequentially imaged, the image of the presence range of the specimen 14 can be acquired without any omission.

FIG. 5C shows a method in which the specimen 14 is detected by following the peripheral part of the specimen 14. Numbers that are nestled in parentheses in FIG. 5C represent an imaging order by the present method. In the drawing, the small section 801 indicated by (1) is imaged by the main imaging device 200, and the distribution calculation portion 131 acquires the two-dimensional distribution of the focus evaluation index of the imaged small section 801 and compares the values of the focus evaluation index with the above threshold value. The presence range of the specimen 14 is acquired through the comparison. That is, the area in the section 801 is divided into the presence area and the non-presence area of the specimen 14. The specimen estimation portion 132 receives the presence range from the distribution calculation portion 131, and detects the boundary line as the peripheral part of the specimen 14 based on data on the presence range consisting of the presence area and the non-presence area as the reception result. Note that the specimen estimation portion 132 detects the boundary line but, in the case where the above two areas can be detected, the boundary line can be considered to be detected, and hence the boundary line itself does not necessarily need to be detected. That is, it is only necessary to be able to detect the boundary between the two areas. Further, the specimen estimation portion 132 determines an intersection point of the detected boundary line and the side of the small section 801. The determined intersection points correspond to points indicated by solid line circles on the right and left of (1) in the drawing. The specimen estimation portion 132 estimates the small section 801 that has the side sharing the intersection point and is not imaged yet as the small section 801 that is imaged next. Since the small section 801 shares the intersection point, the small section 801 includes an extended line of the above boundary, and includes part of the peripheral part of the specimen 14. The setting portion 133 receives data on the section 801 that is imaged next as the estimation result from the specimen estimation portion 132. Based on the data, the main imaging device 200 sets the area that is imaged next. Note that, in order to cope with the case where a plurality of sides satisfying this condition are present and the case where a plurality of the intersection points are present on one side, in addition to a condition that, e.g., a clockwise imaging order is adopted, a condition that the area that is already imaged is not imaged again is provided. Thus, it is possible to perform the imaging in the order of (1)→(2)→(3)→(4) in the drawing so as to follow and detect the peripheral part of the specimen 14.

Note that, in the case where a plurality of the specimens 14 are present in one slide 10, first, it is determined that a plurality of the specimens are present by the following method. That is, by the same method as that described above, it is possible to detect that at least one dark-colored section that can be easily determined as the specimen definitely is present in each of areas completely separated by colorless sections in FIG. 5A. That is, the detection result serves as information indicative of the number of specimens 14 present in one slide 10. By applying the above imaging method to each of the detected specimens 14, it is possible to cope with the case where a plurality of the specimens 14 are present in one slide 10. In addition, when a user manually selects one part of the inside of each of the specimens 14 while watching the wide-area image on a monitor, it is also possible to perform the imaging process by using the part as the initial imaging section using the detection method in which the peripheral part of the specimen 14 is followed. In this case, Step S102 as the specimen presence rough detection process and Step S103 as the imaging start point setting process are manually executed, and hence it is not necessary to execute them on the device side.

As described thus far, the peripheral part of the specimen 14 is followed and detected based on the two-dimensional distribution of the focus evaluation index (the presence range of the specimen 14) in one small section 801 that is already imaged. By doing so, it is possible to perform the main imaging of the entire specimen 14 with high accuracy without any omission even without using a high-accuracy wide-area imaging device. In addition, it is not necessary to set the imaging range of the main imaging of the specimen 14 at the stage of the wide-area imaging (preliminary imaging), and hence it is possible to use the inexpensive wide-area imaging device having a simple configuration.

### Second Embodiment

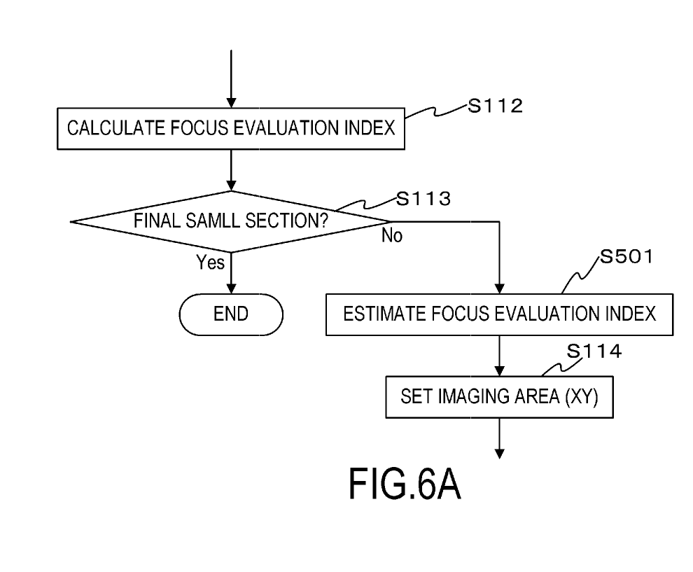

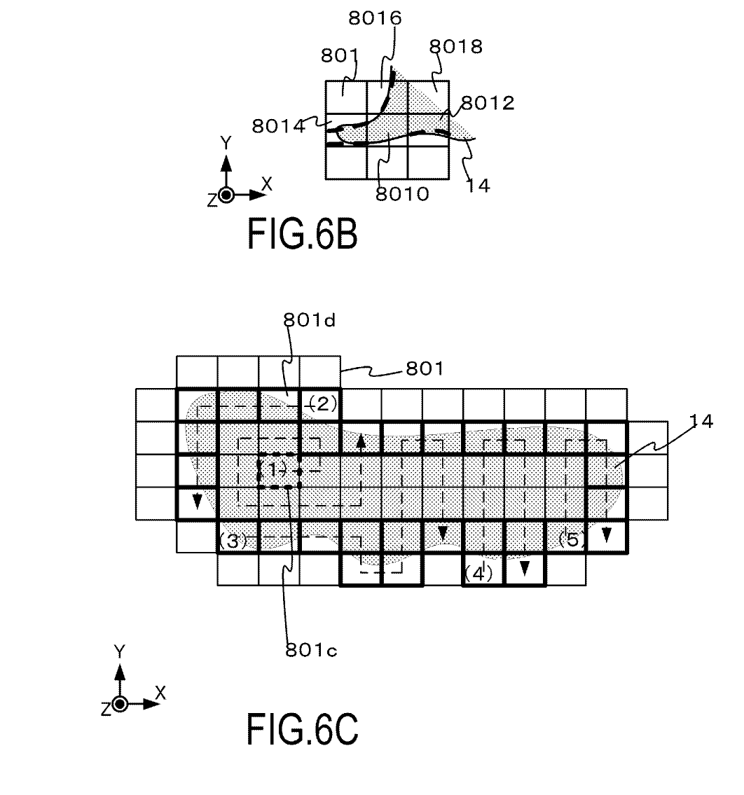

FIG. 6 is a schematic diagram showing a second embodiment of the image acquisition device of the present invention, and components common to the first embodiment are designated by the same reference numerals and the description thereof will be omitted.

(Component)

The arithmetic operation portion 130 includes the distribution calculation portion 131, the specimen estimation portion 132, and the setting portion 133. The arithmetic operation portion 130 determines the XY direction imaging position and the Z direction imaging position after performing the operations related to the focus search, the AF, and the imaging range based on the main imaging data received from the imaging element 240. Subsequently, the arithmetic operation portion 130 outputs the determination result to the control portion 110. The distribution calculation portion 131 calculates the two-dimensional distribution of the focus evaluation index (e.g., the contrast value) representing the presence range of the specimen 14 based on the main imaging data, and outputs the calculation result to the specimen estimation portion 132. The specimen estimation portion 132 outputs distribution information on the presence or absence of the specimen in the surrounding area estimated by a method described later to the setting portion 133. Based on the estimation result, the setting portion 133 sequentially sets the small section 801 that is imaged next such that the presence range of the specimen 14 can be detected and imaged without any omission, and outputs the setting result to the control portion 110. The control portion 110 moves the slide 10 based on the setting result. Further, the control portion 110 synchronizes the imaging timing of the main imaging device 200 and the timing of the movement. Note that the operation of the arithmetic operation portion 130 will be described in detail in the section of (calculation of XY direction imaging range).

(Imaging Process)

FIG. 6A is a flowchart showing part of the imaging process of the device 1 in the present embodiment. In this flowchart, Step S112 to Step S114 as part of the main imaging process in FIGS. 2A and 2B are used, and Step S501 peculiar to the present embodiment is added between Step S113 and Step S114. The flow is the same as that of the first embodiment except the added Step S501, and the detailed description thereof will be omitted.

Similarly to the first embodiment, in Step S112, the distribution calculation portion 131 calculates the two-dimensional distribution of the focus evaluation index based on the acquired main imaging data, and NO is selected in the case where the small section of which the two-dimensional distribution is calculated is not the final small section in Step S113. In Step S501, an extrapolation operation is performed on the two-dimensional distribution of the focus evaluation index of the small section 801 calculated in Step S112, and the two-dimensional distributions (presence or absence of the specimen) of the focus evaluation index in eight adjacent small sections 801 are thereby estimated. In Step S114, when the specimen 14 is determined to be present as a result of the estimation, the small section 801 that is determined as the section in which the specimen 14 is present and is imaged next is set. Steps S112, S501, and S114 will be described in detail in the section of (calculation of XY direction imaging range in second embodiment). Note that the flow up to the setting of the initial imaging section (S103) described by using FIG. 5A is the same as the flow in the first embodiment, and hence the detailed description thereof will be omitted.

### Calculation of XY Direction Imaging Range in Second Embodiment

Each of FIGS. 6B and 6C is a schematic view showing the summary of a calculation method of the XY imaging range after the initial imaging section is set.

FIG. 6B is a view showing a method for estimating and detecting the presence range of the specimen 14 in the second embodiment of the present invention. FIG. 6B shows the case where a small section 8010 is subjected to the main imaging. First, the distribution calculation portion 131 calculates the two-dimensional distribution of the focus evaluation index in the small section 8010 based on the main imaging data. Subsequently, the distribution calculation portion 131 compares each value of the focus evaluation index of the two-dimensional distribution with the predetermined threshold value to thereby detect the boundary of the specimen presence range indicated by solid lines in the frame of the small section 8010 and calculate the presence range (the two-dimensional distribution) of the specimen 14. Next, the specimen estimation portion 132 performs the extrapolation operation on the two-dimensional distribution of the focus evaluation index representing the presence range of the specimen to thereby estimate the two-dimensional distribution of the focus evaluation index (the presence range of the specimen 14) in each of the eight small sections 801 that surround the small section 8010. The estimation result is indicated by a thick dotted line in the drawing. The thick dotted line corresponds to the estimation of the presence range of the specimen 14 in the eight surrounding small sections. Thus, the specimen estimation portion 132 estimates that the specimen 14 is present in four small sections 8012, 8014, 8016, and 8018 among the eight surrounding small sections of the small section 8010 represented by the thick frame. Next, the setting portion 133 receives the estimation result from the specimen estimation portion 132, and determines the four small sections 8012, 8014, 8016, and 8018 as candidates for the next main imaging. It is assumed that the small section 8012 on the right of the small section 8010 represented by the thick frame has already been imaged and then the small section 8010 represented by the thick frame has been imaged. That is, when the small sections 801 have been imaged sequentially in the order described above, the setting portion 133 determines the remaining three small sections 8014, 8016, and 8018 as the candidates for the next imaging. Subsequently, one of the small sections is set as the next imaging target according to a method described later.

FIG. 6C is a view showing the process of estimation and detection of the presence range of the specimen 14 in the second embodiment of the present invention. A rectangle 801d represented by a thick solid line frame in the drawing is the small section 801d in which the peripheral part of the specimen 14 is included. First, the selection portion selects the initial imaging section 801c. Subsequently, the main imaging device 200 performs the main imaging on the selected section 801c, and the focused image of the section 801c is thereby acquired. Next, the distribution calculation portion 131 receives the focused image from the main imaging device 200, and calculates the two-dimensional distribution of the focus evaluation index (the presence range of the specimen 14 in the section 801c) in the initial imaging section 801c based on the focused image. Next, the specimen estimation portion 132 receives the two-dimensional distribution from the distribution calculation portion 131, and estimates the two-dimensional distribution of the focus evaluation index of each of the eight sections around the initial imaging section 801c based on the two-dimensional distribution by the extrapolation operation. In the case of FIG. 6C, the specimen estimation portion 132 estimates that the specimen 14 is present in all of the surrounding eight sections, and inputs the estimation result to the setting portion 133. The setting portion 133 sets the small section that is subjected to the main imaging next based on the estimation result from the specimen estimation portion 132. In this case, the area serving as the target of the main imaging is sequentially set along a dotted line arrow indicated by (1) in the drawing according to a predetermined movement direction (a direction that is close to the initial imaging section 801c, is as adjacent to the initial imaging section 801c as possible, and spreads concentrically in FIG. 6C). The calculation of the two-dimensional distribution, the estimation of presence or absence of the specimen 14 in the surrounding areas, the movement of the imaging area, and the main imaging are repeated in this order in the subsequent process, and the imaging area is moved while the presence range of the specimen 14 is sequentially estimated and detected along the dotted line arrows (2)→(3)→(4)→(5) in the drawing. Thus, it is possible to acquire the image of the presence range of the specimen 14 without any omission.

Note that the extrapolation operation used in the present embodiment is a publically known technique, and various methods are known. The shape of the specimen 14 is not limited to a simple plate-like shape and there are cases where the specimen 14 has a complicated shape, and hence there is a possibility that an estimation error is increased in linear extrapolation. Therefore, it is desirable to perform extrapolation that uses a spline function having an order that is as high as possible.

In addition, the present embodiment has described the method for estimating the two-dimensional distribution of the focus evaluation index of the adjacent small section 801 around the small section 801 by performing the extrapolation operation on the two-dimensional distribution of the focus evaluation index of one small section 801 that is already imaged. However, in order to improve accuracy, it is also desirable to perform the extrapolation on data on the two-dimensional distributions of the focus evaluation index of two or more small sections 801 that are already imaged. As the data amount of the two-dimensional distribution data used in the extrapolation operation is larger, the extrapolation accuracy can be expected to be further improved.

With the above method, it is possible to perform the main imaging having excellent accuracy on the entire area of the specimen 14 without any omission at high speed without using the high-accuracy wide-area imaging device (preliminary imaging device). Further, since high resolving power or high resolution are not required of the wide-area imaging device, it is possible to constitute the device at low cost. In addition, since it is only necessary to determine the initial imaging section 801c based on the contrast or the like and sequentially perform the imaging with the predetermined simple algorithm, it is possible to easily constitute the device.

### Third Embodiment

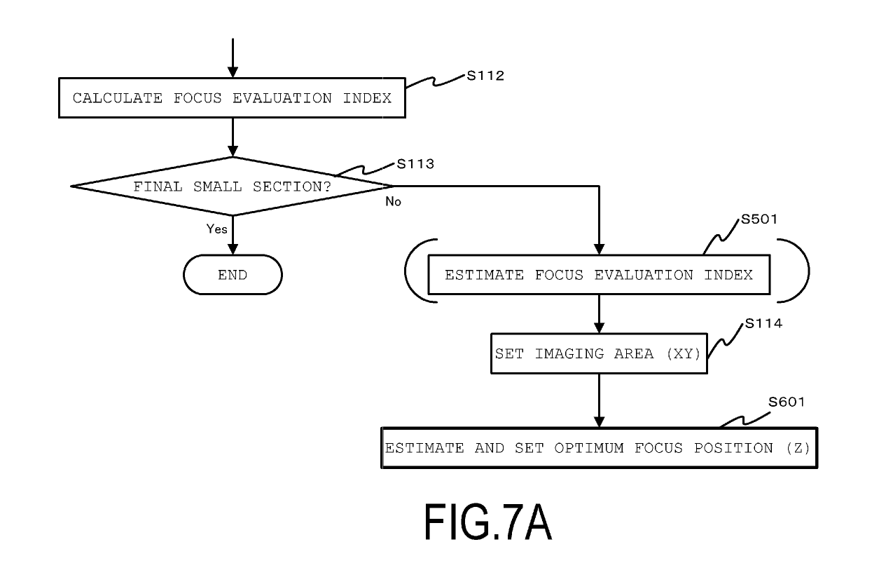

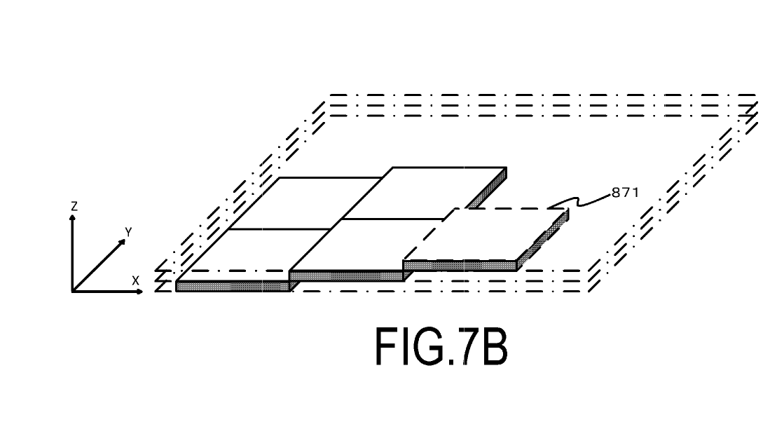

FIG. 7 is a schematic diagram showing a third embodiment of the image acquisition device of the present invention, and components common to the first embodiment and the second embodiment are designated by the same reference numerals and the description thereof will be omitted.

(Component)

In addition to the function described above, the distribution calculation portion 131 calculates the two-dimensional distribution of an optimum focus position of the specimen 14 based on the AF result or Z imaging position setting information in the area that is already imaged, and outputs the calculation result to the specimen estimation portion 132. In addition to the function described above, the specimen estimation portion 132 estimates distribution information on the optimum focus position of the specimen in the surrounding area, and outputs the distribution information to the setting portion 133. In addition to the function described above, the setting portion 133 sets the imaging position in the Z direction in the small section 801 that is imaged next to the estimated optimum focus position, and outputs the setting result to the control portion 110.

(Imaging Process)

FIG. 7A is a flowchart showing part of the imaging process of the device 1 in the present embodiment. In the flowchart, Step S601 peculiar to the present embodiment is added to the flowchart in FIG. 6A after Step S114. The flowchart is the same as that of the first embodiment (without Step S501) or the second embodiment (with Step S501) except the added Step S601, and the detailed description thereof will be omitted. The detail of Step S601 will be described in the section of (estimation of Z direction optimum focus position in third embodiment).

In Step S601, the distribution calculation portion 131 performs the extrapolation operation on the two-dimensional distribution of the optimum focus position as an accumulation of the AF result or the Z imaging position setting information in the area that is already imaged. Subsequently, the optimum focus position in the adjacent small section 801 (set in Step S114 immediately before this Step) that is imaged next is estimated. Then, the estimation result is set as the imaging position in the Z direction, and the flow proceeds to the subsequent process.

### Estimation of Z Direction Optimum Focus Position in Third Embodiment

FIG. 7B schematically shows the summary of a state in which, in the third embodiment, the optimum focus position of the small section 801 that is imaged next is estimated from the distribution of the optimum focus position as the accumulation of the AF result or the Z imaging position setting information in a plurality of the small sections 801 that are already imaged by the extrapolation operation, and the estimation result is set as a next imaging range 871. The drawing shows the case where the optimum focus position in the small section 801 that is imaged next is estimated from the optimum focus positions of the four small sections 801. Theoretically, as the number of small sections 801 as estimation sources is larger, the estimation accuracy of the optimum focus position that is imaged next is higher. That is, the estimation accuracy in the imaging in a prepared slide performed later is higher, and hence it is possible to omit Step S110. On the other hand, in the initial stage of the imaging in which the number of small sections 801 as the estimation sources is small, in order to secure the estimation accuracy, it is desirable to execute the AF in Step S110 in the small section 801 that is imaged. Functions of determining the timing of omitting the AF and switching to the estimation method based on the extrapolation during the imaging process and determining whether the switching is performed immediately or gradually may be implemented by empirically determining an optimum design value according to throughput and accuracy required of the system.

As described thus far, by determining the optimum focus position in the area that is imaged next from the distribution of the optimum focus position as the accumulation of the AF result or the Z imaging position setting information in the area that is already imaged by the extrapolation operation and setting the determination result as the imaging position, it is possible to efficiently acquire a single-layer image of the specimen. Note that the imaging method of the present embodiment may also be combined with various imaging methods of other inventions, and the imaging method of the present embodiment is not limited in any way. For example, the focus evaluation index is calculated from imaging data on the next imaging range 871, and it may be determined whether or not the imaging position obtained as the result of calculation of the evaluation index corresponds to the optimum focus position and, only in the case where it is determined that the imaging position does not correspond to the optimum focus position, the AF may be performed again. At this point, the layer that has been imaged again is determined as the optimum focus position. With this, it is possible to realize a further improvement in accuracy in the subsequent estimation.

### Fourth Embodiment

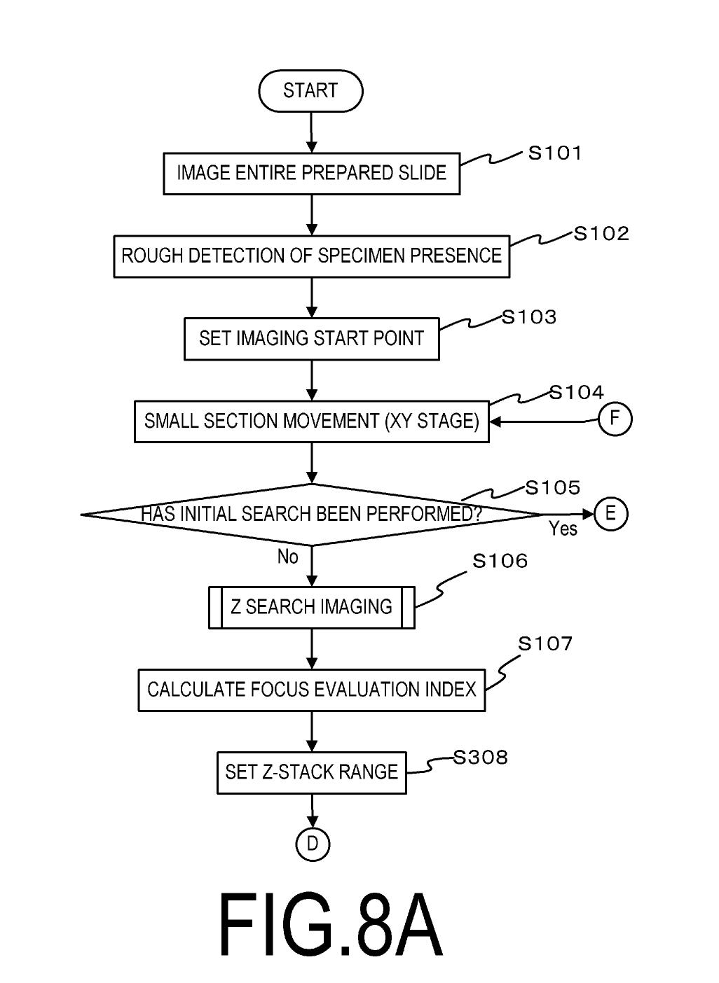

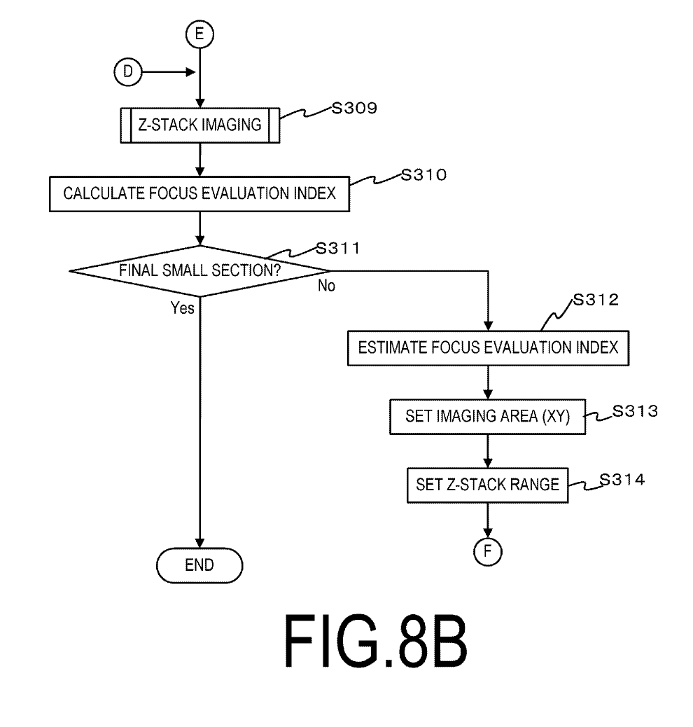

FIGS. 8A and 8B are flowcharts showing a fourth embodiment of the image acquisition device of the present invention, and components common to the first embodiment are designated by the same reference numerals and the description thereof will be omitted.

(Imaging Process)

The imaging process in the fourth embodiment of the device 1 is roughly divided into the following three steps. That is, they are the preliminary imaging in Step S101 to Step S103 that is the same as that of the first embodiment, the initial Z search in Step S104 to Step S308, and the main imaging in Steps S104, S105, and S309 to S314. Prior to them, as a preparation stage of the image acquisition, the slide 10 is placed on the sample placement portion 310. The placement may be automatically performed using the sample transport means from the slide stocker or may be manually performed. Note that the preliminary imaging is the same as that of the first embodiment, and hence the detailed description thereof will be omitted.

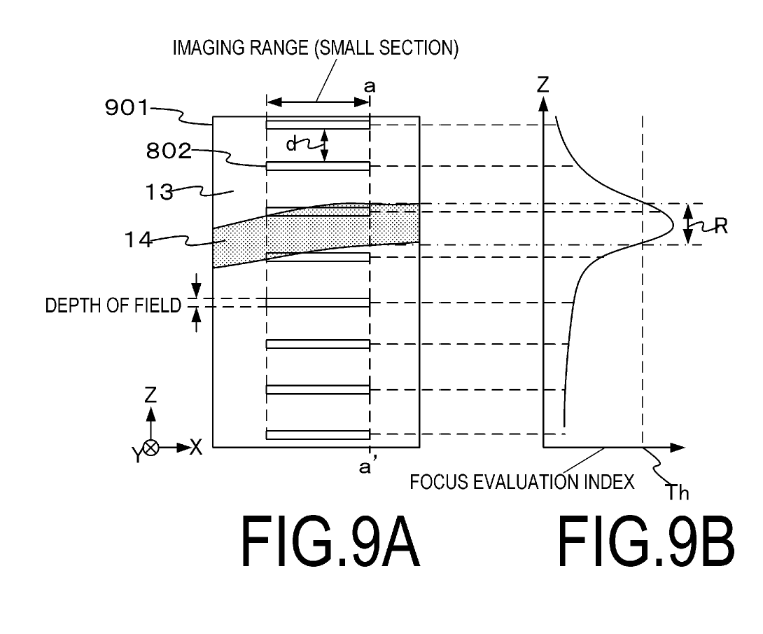

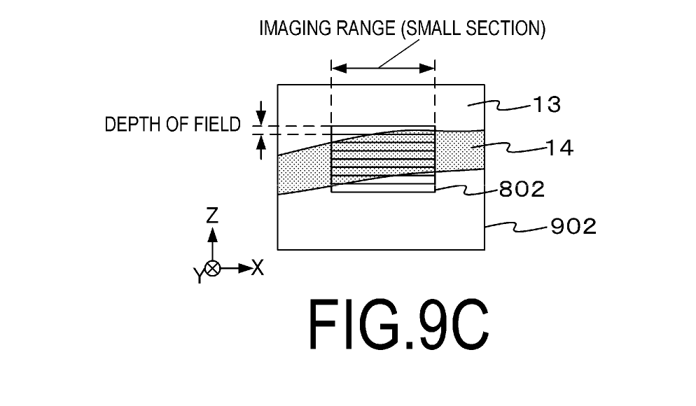

When the preliminary imaging (the wide-area imaging) in Step S101 to Step S103 performed by the wide-area imaging device 300 is ended, the selection portion determines the initial imaging section 801c from the preliminary imaging result. In Step S104, based on the determination, the control portion 110 moves the stage 220 on which the slide 10 is placed such that the small section 801c in which the first imaging by the main imaging device 200 is performed is positioned immediately below the lens. In Step S105, since the main imaging device 200 has not performed the initial search process at this point of time, NO is selected and the flow proceeds to Step S106. In Step S106, the flow proceeds to the imaging process for the Z search performed only in the initial imaging section 801c as the process performed by the main imaging device 200. In Step S107, the distribution calculation portion 131 calculates the focus evaluation index based on the multi-layer imaging data in the Z direction acquired in Step S106. Further, the distribution calculation portion 131 compares the calculation result with a threshold value Th in FIG. 9B described later to thereby calculate a presence range R of the specimen 14 in the Z direction as the comparison result. In Step S308, the control portion 110 sets the Z-stack range for performing the main imaging so as to cover the calculated presence range R. Note that the Z-stack range is a range from the focal position (the position in the Z direction) at the time of the first imaging to the focal position (the position in the Z direction) at the time of the last imaging. The Z-stack means a process in which a plurality of the two-dimensional images are obtained by imaging the subject while slightly changing the focal position in the optical axis direction. A series of the processes for setting the Z-stack range including the processes in Steps S106, S107, and S308 are imaging processes for detecting the specimen presence range in the optical axis direction, i.e., the Z direction, and will be described in detail in the section of (search of Z direction imaging range). In S105, NO is selected only at the first time, and only YES is selected from the second time until all of the imaging processes to the slide are ended.

When Step S308 as the process in which the control portion 110 sets the Z-stack range in the initial imaging small section 801c determined by the selection portion as described above is ended, in Step S309, the main imaging device 200 performs the Z-stack on the small section 801c. Step S309 will be described in detail in the section of (successive multi-layer imaging in Z direction). In Step S310, the distribution calculation portion 131 calculates a three-dimensional distribution of the focus evaluation index based on successive multi-layer imaging data (Z-stack image data) acquired in Step S309. In Step S311, the above final small section determination portion determines whether or not the small section as the current imaging target is the final small section. Herein, the small section is not the final small section, and hence NO is selected and the flow proceeds to Step S312. In Step S312, the specimen estimation portion 132 estimates the three-dimensional distribution of the focus evaluation index in each of eight adjacent small sections 801 around the initial imaging small section 801c based on the three-dimensional distribution of the focus evaluation index of the initial imaging small section 801c calculated in Step S310. Note that the three-dimensional distribution of the focus evaluation index is data in which the two-dimensional distributions of the focus evaluation index determined for a plurality of layer images constituting the Z-stack image are combined with each other. In Step S313, the setting portion 133 extracts the small section 801 in which the specimen 14 is present from the eight small sections 801 based on the input of the three-dimensional distribution from the specimen estimation portion 132. Subsequently, the setting portion 133 sets the small section 801 that is imaged next by using the method described in the second embodiment. In Step S314, the setting portion 133 sets the Z-stack range so as to include the entire presence range of the specimen 14 estimated by the specimen estimation portion 132 in the small section 801 set so as to be imaged next. Note that Steps S310 and S312 to S314 will be described in detail in the section of (setting of Z direction imaging range). After the process in Step S314, the flow proceeds to Step S104 again. In Step S104, the control portion 110 receives the setting result from the setting portion 133, and moves the stage to the small section 801 in which the main imaging is performed next in the XY direction. Thereafter, the main imaging process represented in Steps S104, S105, and S309 to S314 is repeated until the imaging of all of the small sections that include the specimen 14 is ended, YES is selected in S311 at the time of imaging of the final small section, and the imaging process of the slide 10 is ended.

(Search of Z Direction Imaging Range)

FIG. 9 is a schematic view showing a search method of the Z direction imaging range in the fourth embodiment. In FIG. 9A, the one-dot chain line area 901 in the transverse sectional image of the slide 10 shown in FIG. 3A is enlarged, and the method in Step S106 as the Z search imaging process performed only on the first small section 801c is shown in combination. The imaging range 802 is determined by the imaging range (the small section) in the XY direction and the depth of field in the Z direction, and is a three-dimensional area that can be imaged with one exposure. In FIG. 9A, a plurality of the imaging ranges 802 are disposed at regular intervals of the distance d in the Z direction. The imaging ranges 802 are disposed from the upper end of the area 901, i.e., a part in the vicinity of the lower end of the cover glass 11 to the lower end of the area 901, i.e., the upper end of the slide glass 12. By setting the distance d between the imaging ranges 802 to a value substantially equal to the thickness of a thin specimen (about several um), it is possible to include all of the ranges in which the specimen 14 can be present. With this arrangement, an area in which the specimen 14 overlaps any of the imaging ranges 802 is produced due to the distortion of the specimen 14 or the like. Accordingly, it is possible to include all of the ranges in which the specimen 14 can be present.

The flowchart of the Z search imaging, i.e., the subroutine in Step S106 corresponds to a series of the processes shown in the flowchart in FIG. 4. This is the same as that of the first embodiment, and hence the detailed description thereof will be omitted. FIG. 9B schematically shows the distribution of the focus evaluation index on a line of an a-a′ cross section in FIG. 9A (the right end of the imaging range). The distribution calculation portion 131 receives imaging data obtained by performing the main imaging on the eight imaging ranges 802 in FIG. 9A by the main imaging device 200, and the distribution calculation portion 131 interpolates the imaging data in the Z direction, and calculates the distribution of the focus evaluation index (S107). As the focus evaluation index, it is possible to use the contrast and the brightness of the image. In Step S308, the control portion 110 sets the Z-stack range so as to include the entire specimen presence range R. The specimen presence range R is a width R of the focus evaluation index having a value of not less than the pre-set specific threshold value Th in the Z direction. Further, the presence range R of the specimen 14 in the Z direction can also be regarded as the thickness of the specimen 14, and hence the range R can be determined as the specimen thickness. According to the present main imaging process, it is possible to acquire the multi-layer image of the specimen 14 properly.

(Successive Multi-Layer Imaging in Z Direction)

In FIG. 9C, a one-dot chain line area 902 in the transverse sectional image of the slide 10 shown in FIG. 3A is enlarged, and the method of the Z-stack (S309) in the present imaging process is shown in combination. This imaging process is different from the Z search imaging (S106, FIG. 9A) in that the imaging ranges 802 are disposed in the Z-stack range set by the control portion 110 in Step S308 or Step S314 without any gap. The distance between the imaging ranges 802 at this point, i.e., the distance of the step movement of the imaging system in the Z direction is set to be equal to or smaller than the depth of field.

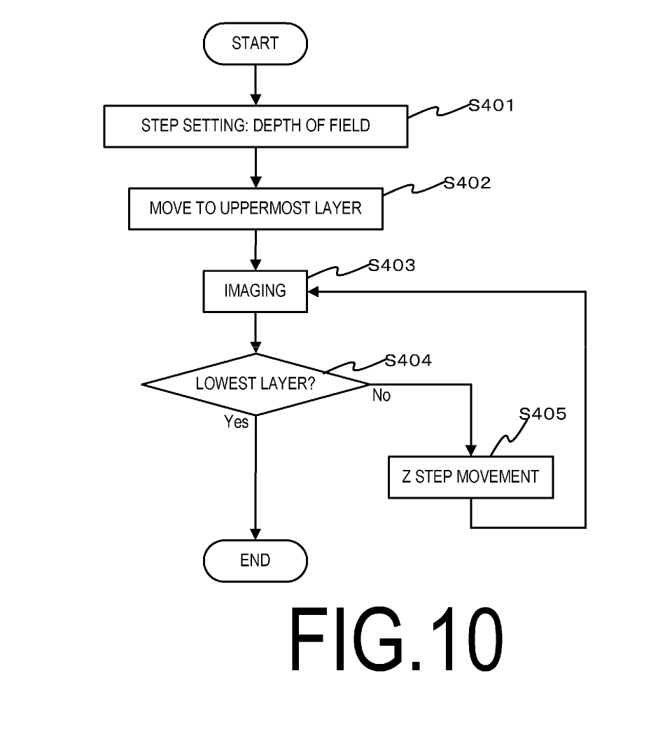

FIG. 10 is a flowchart showing the Z-stack in the third embodiment. That is, the subroutine in Step S309 consists of the individual processes shown in FIG. 9. The flow is started by selecting NO in Step S105 in FIGS. 8A and 8B. In Step S401, first, the imaging interval in the Z direction, i.e., the distance between the imaging ranges 802 is set to be equal to the depth of field of the imaging system by the control portion 110. In Step S402, the control portion 110 moves the stage 220 in the Z direction such that the first imaging layer of the Z-stack can be imaged, and the main imaging device 200 performs the main imaging in Step S403. In Step S404, a lowest layer determination portion (not shown) determines whether or not the imaging layer has reached the last imaging layer. Thereafter, in Step S405, the control portion 110 moves the stage by the step movement in the Z direction by the distance determined in Step S401 so that the next imaging layer can be imaged. Thereafter, Step S403 to Step S405 are repeated, YES is selected in Step S404 at the time point when the imaging layer has reached the last lowest layer in the Z-stack range, and the Z-stack is ended and the flow is ended. Note that the Z step movement direction, i.e., the imaging start Z position in Step S402 and the imaging end Z position in Step S404 do not necessarily need to be in this order.

(Setting of Z Direction Imaging Range)

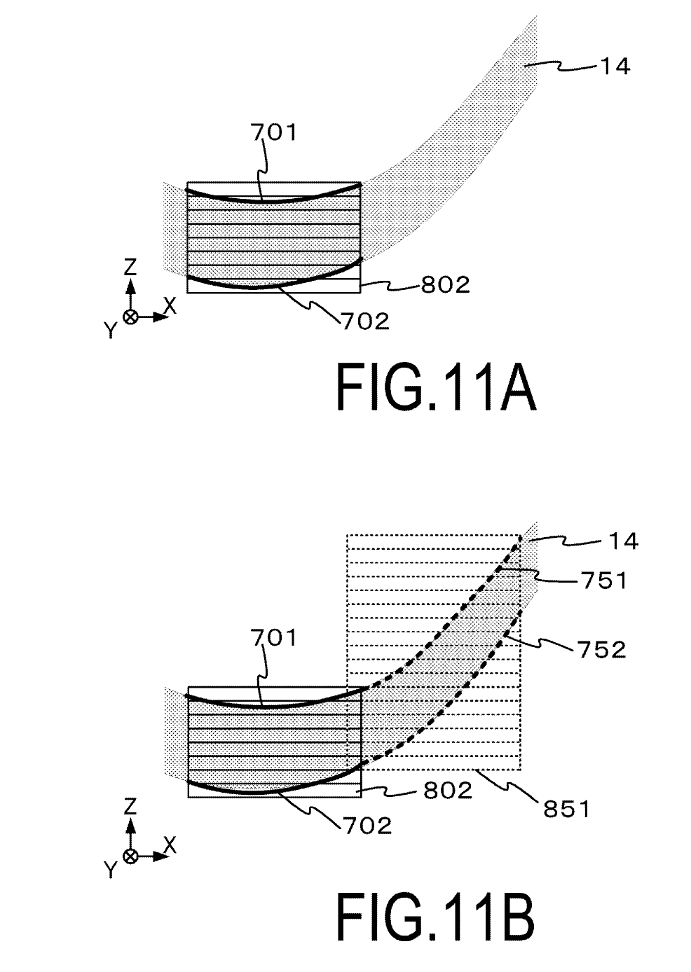

FIG. 11 is a view showing a setting method of the Z-stack range in the third embodiment. FIG. 11A shows a state in which the Z-stack (S309) and the calculation of the focus evaluation index (S310) are completed in a given small section 801. That is, with a plurality of the imaging ranges 802 successively disposed in the Z direction without any gap, image data on a plurality of layers (eight layers in FIG. 11) that properly include the specimen 14 is acquired by the main imaging device 200. Thereafter, based on this, the distribution calculation portion 131 calculates the three-dimensional distribution of the focus evaluation index, and the area having the values of the focus evaluation index that are not less than the predetermined specific threshold value is determined as the specimen presence range. In FIG. 11A, thick solid line parts 701 and 702 represent an upper end surface 701 and an lower end surface 702 of the specimen presence range determined in the manner described above. Note that, although each of the surfaces 701 and 702 is a curved surface in three-dimensional space as described above, FIG. 11 is a transverse sectional view on the XZ plane perpendicular to the Y-axis, and hence each of the surfaces 701 and 702 is depicted as a line in the drawing.

In Step S312, the specimen estimation portion 132 performs the extrapolation operation on the three-dimensional distribution of the focus evaluation index in the small section 801 that is already imaged, and estimates the three-dimensional distribution of the focus evaluation index in each of eight adjacent small sections 801 around the above small section 801. In Step S313, the setting portion 133 sets the small section 801 that is imaged next based on the estimation result.

FIG. 11B shows a state in which the area having the values of the focus evaluation index that are not less than the predetermined specific threshold value is determined as the specimen presence range R from the estimation result, and the Z-stack range is set. Thick dotted line parts 751 and 752 in FIG. 11B represent an upper end surface 751 and a lower end surface 752 of the specimen presence range estimated in the manner described above. Note that, although each of the surfaces 751 and 752 is actually a curved surface in three-dimensional space as described above, FIG. 11 shows a transverse sectional view obtained by virtually cutting the specimen presence range and the image data with the XZ plane, and hence each of the surfaces 751 and 752 is depicted as a line in the drawing. An area 851 indicated by a thin dotted line in the drawing shows the Z-stack range that is imaged next, and includes the entire specimen presence estimation range sandwiched between 751 and 752 in the imaging range. As a method for estimating the three-dimensional distribution of the focus evaluation index in each of the eight adjacent small sections 801 around the small section 801 from the three-dimensional distribution of the focus evaluation index such as the contrast value of the small section 801 that is already imaged, the extrapolation method is used in the present embodiment. The extrapolation operation is a publically known technique, and various methods are known. The shape of the specimen 14 is not limited to a simple plate-like shape and there are cases where the specimen 14 has a complicated shape, and hence there is a possibility that the estimation error is increased in linear extrapolation. Therefore, it is desirable to perform the extrapolation that uses a spline function having an order that is as high as possible.

Note that the present embodiment has described the method for estimating the three-dimensional distribution of the focus evaluation index of each of the adjacent small sections 801 around the small section 801 by performing the extrapolation operation on the three-dimensional distribution of the focus evaluation index in one small section 801 that is already imaged. However, in order to improve accuracy, it is also desirable to perform the extrapolation on data on the three-dimensional distributions of the focus evaluation index in two or more small sections 801 that are already imaged. As the area of the three-dimensional distribution data used in the extrapolation operation is larger, extrapolation accuracy can be expected to be further improved. In addition, among the adjacent small sections 801 around one small section 801 that is already imaged, it is not necessary to perform the operation again on the small section 801 that is already imaged and of which the three-dimensional distribution of the focus evaluation index is calculated. With this, it is possible to shorten an operation time.

As described thus far, the extrapolation operation is performed on the three-dimensional distribution of the focus evaluation index in one or more small sections 801 that are already imaged, and the estimated three-dimensional distribution of the focus evaluation index of the small section 801 adjacent to the above small section 801 is thereby acquired. Subsequently, based on the three-dimensional distribution, the small section 801 that is imaged next and the Z-stack range are set. By doing so, it is possible to acquire the multi-layer image of the specimen 14 without adding a special focus device mechanism such as a phase difference AF device. Further, it is possible to omit the process of the Z search imaging for the small sections 801 other than the small section 801 that is imaged first, and improve the throughput of the device.

### Fifth Embodiment

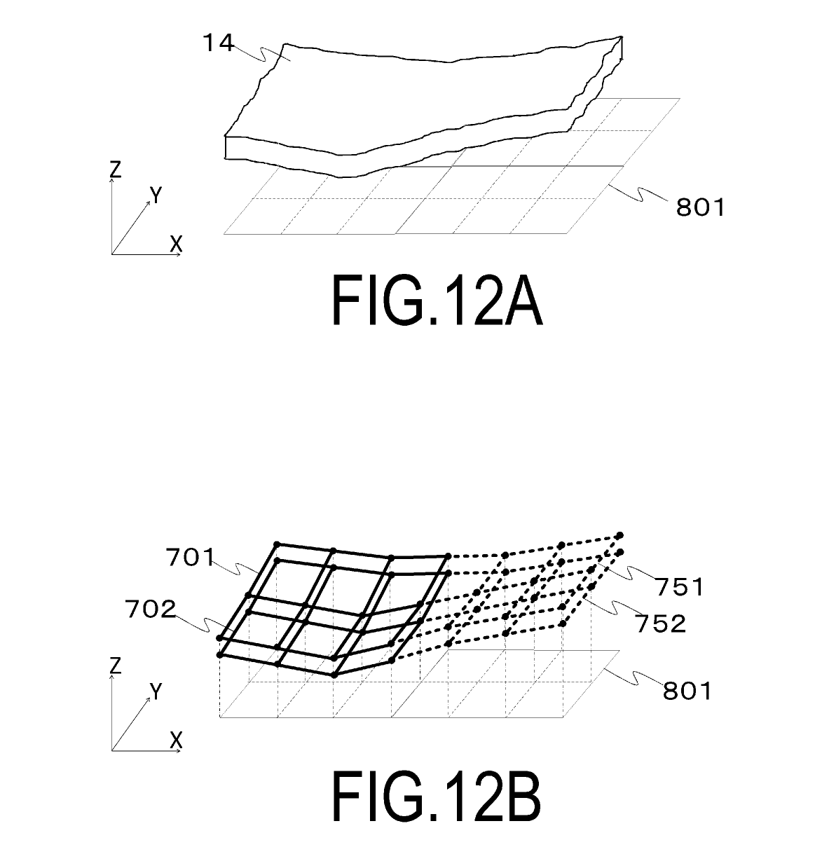

FIG. 12 is a perspective view showing a fifth embodiment of the image acquisition device of the present invention. Components common to the first embodiment are designated by the same reference numerals and the description thereof will be omitted.

The calculation process of the three-dimensional distribution of the focus evaluation index based on the image data acquired by the Z-stack in the distribution calculation portion 131 and the operation amount of the extrapolation operation process of the three-dimensional distribution in the specimen estimation portion 132 depend on the number of pixels of the imaging element 240. Consequently, in the case where data on all of the pixels of the image data acquired by the Z-stack is used, the operation amount is large. In the present embodiment, instead of using the data on all of the pixels in each process described above, only data on a plurality of points or areas extracted at predetermined intervals is used. That is, in the first to fourth embodiments, the contrast value or the brightness value is calculated for all of the pixels, but the calculation is performed not on all of the pixels but on some of the pixels in the fifth embodiment.

FIG. 12A is a view showing a relationship between the small section 801 and the specimen 14. One small section 801 having a thin solid line frame is partitioned into six small areas using thin dotted lines, whereby 12 lattice points are present in the areas including those on the boundary line between the areas and the adjacent small sections 801. FIG. 12B is a view showing a three-dimensional plot of the specimen presence range. That is, a thick solid line group is obtained by three-dimensionally plotting the specimen presence range determined based on a plurality of one-dimensional distributions described later. That is, the one-dimensional distributions correspond to a plurality of one-dimensional distributions of the focus evaluation index calculated by using data present on a straight line passing through the lattice point and parallel with the Z-axis among image data acquired by the Z-stack in the small section 801 at the lower left that is already acquired. The thick solid line part 701 is the upper end surface 701 of the specimen presence range, and the thick solid line part 702 is the lower end surface 702 thereof. A thick dotted line group in FIG. 12B represents the specimen presence range determined by performing the extrapolation operation on the plurality of the one-dimensional distributions of the focus evaluation index and estimating the distributions on the lattice points of the surrounding small section 801. Note that, for simplification, the range shown in the drawing is limited, and only two small sections including the small section 801 that is already imaged and, among eight adjacent small sections around the small section 801, the small section 801 set as the area that is imaged next are shown. The thick dotted line part 751 is the upper end surface 751 of the estimated specimen presence range, and the thick dotted line part 752 is the lower end surface 752 thereof. Herein, data is actually present only on the straight lines passing through the lattice points including black points in the drawing and parallel with the Z-axis and, for the convenience of drawing, spaces between the black points in the thick line group are subjected to linear interpolation in order to express surfaces. The Z-stack range is set such that the entire specimen presence range in the right small section 801 estimated in this manner is included in the imaging range. Note that the small section 801 is partitioned into six areas in the present embodiment for simplification, but the present invention is not limited thereto, and the operation accuracy is higher as the number of lattice points is larger.

Note that, instead of using the data on all of the pixels in each process described above, a configuration may also be adopted in which switching control that switches between the case where only the data on a plurality of the points or the areas extracted at predetermined intervals is used and the case where the data on all of the pixels is used can be performed. That is, in the case where it is intended to increase the accuracy of the operation result in spite of the increase of the operation amount, a mode is switched to the mode in which the data on all of the pixels is used, and the operation is performed. On the other hand, in the case where it is intended to reduce a time required for the operation instead of increasing the accuracy of the operation result, the mode is switched to the mode in which only the data on a plurality of the points or the areas extracted at predetermined intervals is used, and the operation is performed. Note that, in the present embodiment, the configuration in which only the data on a plurality of the points or the areas extracted at predetermined intervals is used is adopted in order to reduce the operation amount, but the configuration in which the data on all of the pixels is used may also be adopted in the case where it is not necessary to reduce the operation amount or the like.

As described thus far, it is possible to reduce the operation amount by using only the data on the points or the areas extracted at predetermined intervals of the image data acquired by the Z-stack used in the calculation process of the three-dimensional distribution of the focus evaluation index.

### Sixth Embodiment

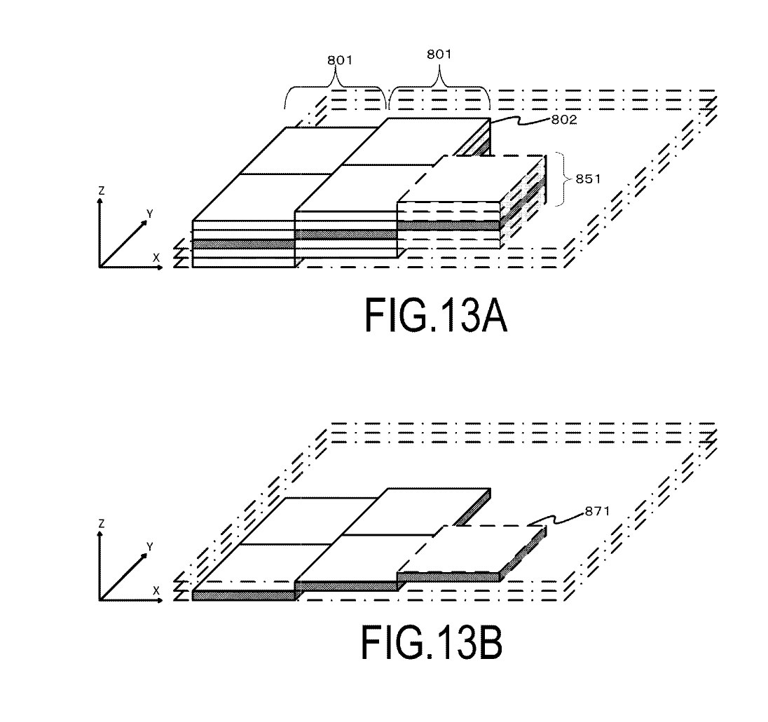

FIG. 13 is a perspective view showing a sixth embodiment of the image acquisition device of the present invention. Components common to the first embodiment and the fourth embodiment are designated by the same reference numerals, and the description thereof will be omitted. The present embodiment relates to an imaging method for efficiently obtaining the single-layer image at the optimum focus position having the best focus in the specimen presence range. Note that, in the imaging method, the Z-stack imaging is not performed in all of the small sections 801. FIG. 13A shows the state of the Z-stack imaging described above. The Z-stack imaging is performed in four small sections 801 arranged in a 2×2 matrix, and the operation of the focus evaluation index is performed. As the result of the operation, one of the group of the imaging ranges 802 that has a mesh pattern is regarded as the optimum focus position. The extrapolation operation is performed based on this, and the Z-stack range 851 that is imaged next including the XY position is set. In the present embodiment as well, as shown in FIG. 13A, the same imaging as that described above is performed in several tiles after the start of the imaging. This is because the first tile requires the Z search imaging. In addition, this is because the estimation accuracy by the extrapolation operation of the optimum focus position is reduced theoretically in the case where only the single-layer image is used immediately after the start of the imaging.

FIG. 13B schematically shows a state in which the optimum focus position of the small section 801 that is imaged next is estimated by the extrapolation operation from the distribution of the optimum focus positions in a plurality of the small sections 801 in which the single-layer imaging is already performed, and is set as the next imaging range 871. In FIG. 13B, for simplification of the description, the arrangement of the small section 801 and the optimum focus position is the same as that of FIG. 13A. FIG. 13B shows the case where the optimum focus position in the small section 801 that is imaged next is estimated from the optimum focus positions of four small sections 801. For the XY position, the method described in the second embodiment is used. Theoretically, the estimation accuracy of the optimum focus position that is imaged next is higher as the number of small sections 801 serving as the estimation sources is larger. Accordingly, the estimation accuracy of the imaging increases as the imaging progresses. Consequently, in the initial imaging in which the number of small sections 801 as the estimation sources is small, it is desirable to perform the imaging of a plurality of layers as in FIG. 13A in order to secure the estimation accuracy, and calculate the three-dimensional distribution of the focus evaluation index. With this, it is possible to adequately secure the estimation accuracy in the initial imaging. In addition, functions of the device of determining the timing of switching to the single-layer imaging during the imaging process and determining whether the switching is performed immediately or gradually may be implemented by empirically determining an optimum design value according to throughput and accuracy required of the system.

As described thus far, the optimum focus position in the area that is imaged next is determined from the distribution of the optimum focus position in the area that is already imaged by the extrapolation operation, and is set as the imaging position. With this, the single-layer image of the specimen is efficiently acquired. Note that the imaging method of the present embodiment may be combined with various imaging method of other inventions, and the imaging method of the present embodiment is not limited in any way. For example, the XY coordinates of the imaging range 802 corresponding to the optimum focus position may be the center of the small section 801, and may also be coordinates of a point at which the focus evaluation index is highest in the small section 801. The latter improves the estimation accuracy of the next imaging range 871.

### Seventh Embodiment

The object of the present invention is achieved by the following. That is, a storage medium (or a recording medium) in which a program code of software for implementing the functions of the embodiments described above is stored is supplied to a system or a device. Subsequently, a computer (or a CPU or an MPU) of the system or the device reads and executes the program code stored in the storage medium. In this case, the program code read from the storage medium implements the functions of the embodiments described above, and the storage medium in which the program code is stored constitutes the present invention.

In addition, by executing the program code read by the computer, an operating system (OS) or the like available on the computer performs part or all of actual processes based on an instruction of the program code. The case where the functions of the embodiments described above are implemented by the processes is included in the scope of the present invention. Further, it is assumed that the program code read from the storage medium is written in a memory provided in a function expansion card inserted into the computer or a function expansion unit connected to the computer. The case where the CPU or the like provided in the function expansion card or the function expansion unit performs part or all of actual processes based on the instruction of the program code thereafter, and the functions of the embodiments described above are implemented by the processes is also included in the scope of the present invention. In the case where the present invention is applied to the storage medium, a program code corresponding to the flowcharts described above is stored in the storage medium. The storage medium (or the recording medium) may be a non-volatile storage medium.

### Other Embodiments

Since a person skilled in the art can easily conceive of appropriately combining various techniques in the above embodiments to constitute a new system, the systems obtained by various combinations are also included in the scope of the present invention. In addition, various implementations of the present invention are not limited to the embodiments described above.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-175944, filed on Aug. 29, 2014 and Japanese Patent Application No. 2015-104802, filed on May 22, 2015 which are hereby incorporated by reference herein in their entirety.

What is claimed is:

1. An image acquisition device dividing a sample into a plurality of areas and sequentially imaging the areas, comprising:
a stage that supports the sample;
an imaging unit that has an image forming optical system forming an image of the sample and captures the formed image;
a specimen information acquisition unit that acquires information on presence or absence of a specimen included in the sample based on an imaging result of the imaging unit; and
a control unit that moves the stage based on the information on the presence or absence of the specimen, wherein
the specimen information acquisition unit determines, based on an image of a first area of the sample captured by the imaging unit, the presence or absence of the specimen in a second area of the sample different from the first area, and
the control unit moves the stage in order to image the second area next when the specimen is determined to be present in the second area.

2. The image acquisition device according to claim 1, wherein
the specimen information acquisition unit acquires a focus evaluation index of each of pixels forming the image of the first area to thereby acquire a two-dimensional distribution of the focus evaluation index in the first area, and determines the presence or absence of the specimen in the second area based on the two-dimensional distribution.

3. The image acquisition device according to claim 2, wherein
the focus evaluation index is a contrast value.

4. The image acquisition device according to claim 2, wherein
the second area is adjacent to the first area.

5. The image acquisition device according to claim 2, wherein
the specimen information acquisition unit determines the presence or absence of the specimen in the second area based on a boundary between an area in which the specimen is present and an area in which the specimen is not present in the first area.

6. The image acquisition device according to claim 5, wherein
the specimen information acquisition unit determines the presence or absence of the specimen in the second area based on an intersection point of the boundary and a periphery of the first area corresponding to an imaging field of the imaging unit.

7. The image acquisition device according to claim 2, wherein
the specimen information acquisition unit estimates the two-dimensional distribution of the focus evaluation index in the second area based on an extrapolation operation performed on the two-dimensional distribution of the focus evaluation index in the first area, and determines the presence or absence of the specimen in the second area based on an estimation result.

8. The image acquisition device according to claim 2, wherein
the specimen information acquisition unit acquires the two-dimensional distribution of the focus evaluation index in the first area from at least part of the pixels forming the image of the first area.

9. The image acquisition device according to claim 2, wherein
the specimen information acquisition unit further estimates an optimum focus position of the specimen in the second area based on an extrapolation operation performed on distribution information on an optimum focus position of the specimen in the first area.

10. The image acquisition device according to claim 1, wherein
the imaging unit acquires an image of a single layer or images of a plurality of layers having different focal positions in an optical axis direction of the image forming optical system, and
the specimen information acquisition unit determines the presence or absence of the specimen in the first area, an optimum focus position of the specimen in the first area, or a distribution of the optimum focus position from the image of the single layer or the images of the plurality of the layers of the first area, and estimates the presence or absence of the specimen included in the second area or an optimum focus position of the specimen in the second area based on the presence or absence of the specimen in the first area, the optimum focus position of the specimen in the first area, or the distribution of the optimum focus position.

11. The image acquisition device according to claim 10, wherein
the specimen information acquisition unit estimates a three-dimensional distribution of a focus evaluation index of each of pixels in the second area based on an extrapolation operation performed on a three-dimensional distribution in the first area, and determines the presence or absence of the specimen in the second area based on an estimation result.

12. The image acquisition device according to claim 10, wherein
the specimen information acquisition unit acquires a three-dimensional distribution of a focus evaluation index in the first area from at least part of pixels forming an image of the first area at each focal position.

13. The image acquisition device according to claim 10, wherein
the specimen information acquisition unit performs an extrapolation operation on the distribution of the optimum focus position in the first area to thereby estimate the optimum focus position in the second area.

14. The image acquisition device according to claim 1, further comprising:
a wide-area imaging unit that captures an entire image of the sample; and
a selection portion that selects an area to be imaged first by the imaging unit from the plurality of the areas, based on the entire image.

15. The image acquisition device according to claim 13, wherein
a resolving power of the wide-area imaging unit is lower than that of the imaging unit.

16. The image acquisition device according to claim 14, wherein
the selection portion selects, as the area to be imaged first by the imaging unit, an area of the entire image having a lowest brightness.

17. The image acquisition device according to claim 1, wherein
the control unit moves the stage such that an area including a boundary of the specimen from among the plurality of the areas follows the boundary of the specimen.

18. A control method for an image acquisition device including a stage that supports a sample, and an imaging unit that captures an image of the sample, comprising the steps of:
capturing an image of a first area of the sample;
determining presence or absence of a specimen in a second area of the sample different from the first area based on the image of the first area; and
moving the stage in order to image the second area next when the specimen is determined to be present in the second area.

19. A non-transitory computer readable storage medium storing a program for causing a computer to execute steps of a control method for an image acquisition device including a stage that supports a sample, and an imaging unit that captures an image of the sample, the method comprising the steps of:
capturing an image of a first area of the sample;
determining presence or absence of a specimen in a second area of the sample different from the first area based on the image of the first area; and
moving the stage in order to image the second area next when the specimen is determined to be present in the second area.
